(19) United States
(12) Patent Application Publication
(10) Pub. No.: US 2017/0047866 A1
(43) Pub. Date: Feb. 16, 2017

(54) POWER GENERATOR

(71) Applicant: MITSUMI ELECTRIC CO., LTD., Tokyo (JP)

(72) Inventors: KENICHI FURUKAWA, SAGAMIHARA-SHI, KANAGAWA (JP); TAKAYUKI NUMAKUNAI, TAMA-SHI, TOKYO (JP)

(21) Appl. No.: 15/305,322

(22) PCT Filed: Feb. 24, 2015
(86) PCT No.: PCT/JP2015/055198

§ 371 Date: Oct. 19, 2016

(30) Foreign Application Priority Data
Apr. 23, 2014 (JP) 2014-088802

(51) Int. Cl. H02N 2/18

(52) U.S. Cl. CPC H02N 2/186

(57) ABSTRACT

A power generator 1 includes at least two magnetostrictive elements 10 each including a magnetostrictive rod through which lines of magnetic force pass in an axial direction thereof and a coil 3 wound around the magnetostrictive rod 2; and a beam member 83 for connecting one end portions of the magnetostrictive elements 10 with each other and the other end portions of the magnetostrictive elements 10 with each other. Further, the power generator 1 includes a permanent magnet 6 for generating the lines of magnetic force passing through the magnetostrictive rods 2. The permanent magnet 6 is provided so that a magnetization of the permanent magnet 6 differs from an arrangement direction in which the magnetostrictive elements 10 are arranged side by side.

### FIELD OF THE INVENTION

The present invention relates to a power generator.

### BACKGROUND ART

In recent years, there has been developed a power generator which can generate electric power by utilizing variation of magnetic permeability of a magnetostrictive rod formed of a magnetostrictive material (for example, see patent document 1).

For example, this power generator includes a pair of magnetostrictive rods arranged side by side, two connecting yokes for respectively connecting one end portions and the other end portions of the pair of magnetostrictive rods with each other, coils arranged so as to respectively surround the magnetostrictive rods, two permanent magnets respectively arranged on the two connecting yokes to apply a bias magnetic field to the magnetostrictive rods and a back yoke. The pair of magnetostrictive rods serve as beams facing each other. When external force is applied to one of the connecting yokes in a direction perpendicular to each axial direction of the pair of the magnetostrictive rods, one of the magnetostrictive rods is deformed so as to be expanded and the other one of the magnetostrictive rods is deformed so as to be contracted. At this time, magnetic permeability of each magnetostrictive rod 2 varies. This variation of the magnetic permeability of each magnetostrictive rod 2 leads to variation of density of lines of magnetic force (magnetic flux density) passing through the magnetostrictive rods (that is density of the lines of magnetic force passing through the coils), thereby generating a voltage in the coils.

In this power generator, it is preferable from a point of view of improving power generation efficiency of the power generator that a winding number of a wire forming each of the coils is large. For increasing the winding number of the wire, it is necessary to sufficiently ensure spaces for winding the coils around the magnetostrictive rods to increase a size of each of the coils. However, it is necessary to ensure a large gap between the magnetostrictive rods around which the coils are respectively wound for sufficiently ensuring the spaces for the coils. Thus, in the case where a size of the power generator is limited, it is difficult to sufficiently ensure the spaces for the coils, and thus it is difficult to sufficiently improve the power generation efficiency of the power generator 1.

Thus, in order to sufficiently improve the power generation efficiency of the power generator with suppressing increasing of the size of the power generator, there has been developed by the inventors of the present invention that a power generator having the following configuration.

This power generator includes a pair of magnetostrictive rods arranged side by side; plate-shaped yokes respectively fixed to one end portions and the other end portions of the magnetostrictive rods and formed of a soft magnetic material; coils respectively wound around the magnetostrictive rods; a connecting portion formed of a non-magnetic material and including a first connecting member for connecting the yokes provided on the side of the one end portion of each of the magnetostrictive rods, a second connecting member for connecting the yokes provided on the side of the other end portion of each of the magnetostrictive rods and a beam member for connecting the first connecting member and the second connecting member; and permanent magnets respectively provided between the yokes provided on the side of the one end portions of the magnetostrictive rods and between the yokes provided on the side of the other end portions of the magnetostrictive rods. The pair of magnetostrictive rods and the beam member serve as parallel beams facing each other. When external force is applied to the yokes provided on the side of the other end portions of the magnetostrictive rods in a direction perpendicular to an axial direction of each of the pair of magnetostrictive rods and the beam member, each of the magnetostrictive rods is deformed so as to be expanded and contracted. At this time, density of lines of magnetic force passing through each of the magnetostrictive rods varies, thereby generating a voltage in the coils. Since the power generator is configured so that the beam member and the pair of magnetostrictive rods do not overlap with each other in a planar view, it is possible to sufficiently reduce the size of the power generator and sufficiently ensure the spaces for respectively winding the coils around the magnetostrictive rods.

In this power generator, in order to form a magnetic field loop passing through the pair of magnetostrictive rods, the yokes respectively fixed to the both end portions of the magnetostrictive rods and the permanent magnets, at least one of the permanent magnets is arranged between the yokes provided on the side of the one end portions or between the yokes provided on the side of the other end portions of the magnetostrictive rods of the power generator so that a magnetization direction of the at least one permanent magnet coincides with an arrangement direction of the magnetostrictive rods. In order to more improve the power generation efficiency of the power generator having such a configuration, it is necessary to apply a sufficient bias magnetic field to the magnetostrictive rods. Examples of a method for applying the sufficient bias magnetic field to the magnetostrictive rods include a method of increasing a square measure of a contacting surface between the at least one permanent magnet and each yoke.

However, in order to increase the square measure of the contacting surface between the at least one permanent magnet and each yoke, it is necessary to enlarge a size of the permanent magnet and make a height of each yoke higher. In this case, although the power generation efficiency of the power generator is improved, the size of the power generator gets bigger as a whole. Thus, in order to suppress the increasing of the size of the power generator and more improve the power generation efficiency of the power generator, it is preferable to use a permanent magnet formed of a rare-earth material, which has superior characteristic such as superior attracting force and a superior maximum energy product. By using such a permanent magnet, it is possible to apply the sufficient bias magnetic field to the magnetostrictive rods even if the square measure of the contacting surface between the permanent magnet and each yoke is small. However, it is difficult to suppress a manufacturing cost of the power generator because the permanent magnet formed of the rear-earth material is expensive. Further, in the power generator having the configuration including the parallel beams as described above, it is preferable that the permanent magnets are respectively provided between the yokes provided on the side of the one end portions of the magnetostrictive rods and between the yokes provided on the side of the other end portions of the magnetostrictive rods so that the magnetization directions of the permanent magnets coincide with the arrangement direction of the magnetostrictive rods in order to efficiently apply the bias magnetic field to both of the magnetostrictive rods. Thus, arrangement positions for the permanent magnets are necessarily determined. Namely, in the case of taking account of the power generation efficiency of the power generator, the arrangement positions for the permanent magnets are restricted.

### RELATED ART

### Patent Document

Patent document 1: WO 2011/158473

### SUMMARY OF THE INVENTION

### Problems to be Solved by the Invention

The present invention has been made in view of the problems mentioned above. Accordingly, it is an object of the present invention to provide a power generator which can efficiently generate electric power with suppressing increasing of a size of the power generator and ensuring a high degree of freedom for design of permanent magnets used in the power generator.

### Means for Solving the Problems

The above object is achieved by the present inventions defined in the following (1) to (16).

(1) A power generator comprising:
at least two magnetostrictive elements arranged side by side, each magnetostrictive element having one end portion and the other end portion;
a connecting portion including a first connecting member for connecting the one end portions of the magnetostrictive elements, a second connecting member for connecting the other end portions of the magnetostrictive elements and at least one beam member for connecting the first connecting member and the second connecting member; and
a permanent magnet for generating lines of magnetic force passing through the magnetostrictive elements, the permanent magnet arranged so that a magnetization of the permanent magnet differs from an arrangement direction in which the magnetostrictive elements are arranged side by side,
wherein each of the magnetostrictive elements includes:
a magnetostrictive rod through which the lines of magnetic force pass in an axial direction thereof, the magnetostrictive rod formed of a magnetostrictive material and having one end portion and the other end portion; and
a coil wound around the magnetostrictive rod, and
wherein the power generator is configured to generate voltage in the coils due to variation of density of the lines of magnetic force when the other end portion of each of the magnetostrictive rods is displaced with respect to the one end portion of each of the magnetostrictive rods in a direction substantially perpendicular to the axial direction of the magnetostrictive rods to expand and contract the magnetostrictive rods.

(2) The power generator according to the above (1), further comprising a magnetic member formed of a magnetic material and attached to the permanent magnet,
wherein the permanent magnet is provided arranged on at least one of the sides of the one end portion and the other end portion of each of the magnetostrictive elements,
wherein the permanent magnet includes:
a first portion having a first magnetization direction perpendicular to the arrangement direction of the magnetostrictive elements; and
a second portion having a second magnetization direction opposed to the first magnetization direction, and
wherein the magnetic member and the magnetostrictive elements form a loop in which lines of magnetic force generated from the first portion flows into the second portion through the magnetic member and lines of magnetic force generated from the second portion flows into the first portion through the magnetostrictive rods.

(3) The power generator according to the above (2), wherein each of the first magnetization direction and the second magnetization direction is parallel to a displacement direction of the other end portion of each of the magnetostrictive elements.

(4) The power generator according to the above (2), wherein each of the first magnetization direction and the second magnetization direction is parallel to the axial direction of each of the magnetostrictive rods.

(5) The power generator according to any one of the above (2) to (4), wherein each of the magnetostrictive elements further includes:
a first block body attached to the one end portion of the magnetostrictive rod, the first block body formed of a magnetic material; and
a second block body attached to the other end portion of the magnetostrictive rod, the second block body formed of a magnetic material, and
wherein the permanent magnet connects the first block bodies of the magnetostrictive elements with each other or the second block bodies of the magnetostrictive elements with each other.

(6) The power generator according to any one of the above (2) to (4), wherein each of the at least two magnetostrictive elements further includes:
a first block body attached to the one end portion of the magnetostrictive rod of each of the magnetostrictive elements, the first block body formed of a magnetic material; and
a second block body attached to the other end portion of the magnetostrictive rod of each of the magnetostrictive elements, the second block body formed of a magnetic material,
wherein each of the first block body and the second block body includes a magnetic field short-circuit portion arranged between the one end portions or the other end portions of the magnetostrictive rods arranged adjacent to the first block body and the second block body and configured to flow a part of the lines of magnetic force between the one end portions or the other end portions of the magnetostrictive rods, and
wherein the permanent magnet is attached to at least one of the first block body and the second block body.

(7) The power generator according to the above (6), wherein the magnetic field short-circuit portion includes a slit formed at a substantially intermediate position between the one end portions or the other end portions of the magnetostrictive rods arranged adjacent to the first block body and the second block body.

(8) The power generator according to the above (7), wherein a width of the slit is in the range of 0.1 to 5 mm and a length of the slit is in the range of 0.5 to 20 mm.

(9) The power generator according to any one of the above (7) or (8), further comprising a pin which is formed of a magnetic material and can be inserted into the slit of each of the first block body and the second block body,
wherein the power generator is configured so that a variation amount of the density of the lines of magnetic force passing through the magnetostrictive rods can be adjusted by inserting the pin into the slit.

(10) The power generator according to any one of the above (1) to (9), wherein the coils respectively wound around the magnetostrictive elements and the beam member are arranged so as not to overlap with each other in a planar view.

(11) The power generator according to any one of the above (1) to (10), wherein the beam member is provided between the magnetostrictive rods in a planar view.

(12) The power generator according to any one of the above (1) to (11), wherein the power generator is configured so that a total number of the magnetostrictive elements and the beam member becomes an odd number.

(13) The power generator according to any one of the above (1) to (12), wherein the magnetostrictive rods of the magnetostrictive elements and the beam member are arranged so as not to overlap with each other in a side view.

(14) The power generator according to any one of the above (1) to (13), wherein the power generator is configured so that a gap between the beam member and each of the magnetostrictive elements on the side of the other end portion of each of the magnetostrictive elements is smaller than a gap between the beam member and each of the magnetostrictive elements on the side of the one end portion of each of the magnetostrictive elements in a side view.

(15) The power generator according to any one of the above (1) to (14), wherein each of the coils includes a bobbin arranged around the magnetostrictive rod so as to surround the magnetostrictive rod and a wire wound around the bobbin, and
wherein a space is formed between the magnetostrictive rod and the bobbin on at least the side of the other end portion of the magnetostrictive rod.

(16) The power generator according to the above (15), wherein the other end portion of each of the magnetostrictive elements is displaced when vibration is applied to each of the magnetostrictive rods, and
wherein the space has a size for preventing the bobbin and the magnetostrictive rods being vibrating from interfering with each other.

### Effects of the Invention

The power generator of the present invention includes at least two magnetostrictive elements arranged side by side and a permanent magnet arranged so that a magnetization of the permanent magnet differs from an arrangement direction in which the magnetostrictive elements are arranged side by side. According to this power generator, it becomes unnecessary to arrange the permanent magnet between the magnetostrictive elements arranged side by side, thereby freely designing a square measure of a contacting surface between the permanent magnet and each of the magnetostrictive elements, an arrangement position of the permanent magnet and an arranged number of permanent magnets. Namely, it is possible to improve a degree of freedom for design of the permanent magnet used in the power generator. In addition, by adjusting the square measure of the contacting surface between the permanent magnet and each of the magnetostrictive elements, the arrangement position of the permanent magnet and the arranged number of permanent magnets, it is possible to suppress increasing of a size of the power generator and provide the power generator which can efficiently generate electric power.

### BRIEF DESCRIPTION OF THE DRAWINGS

FIG. 1 is a perspective view showing a first embodiment of a power generator of the present invention.

FIG. 2 is an exploded perspective view of the power generator shown in FIG. 1.

FIG. 3(a) is a side view for explaining a state that the power generator shown in FIG. 1 is attached to a vibrating body. FIG. 3(b) is a longitudinal cross-sectional view (a cross-sectional view taken along an A-A line in FIG. 1) of the power generator shown in FIG. 1 which is attached to the vibrating body. FIG. 3(c) is a view showing a state that coils are removed from magnetostrictive elements shown in FIG. 3(a).

FIG. 4 is a planar view of the power generator shown in FIG. 1.

Each of FIGS. 5(a) and 5(b) is a perspective view showing a bobbin of each of the coils included in the power generator shown in FIG. 1.

Each of FIGS. 6(a) and 6(b) is a perspective view showing the coil and a magnetostrictive rod included in the power generator shown in FIG. 1. FIG. 6(c) is a perspective view showing cross-sectional surfaces of the coil and the magnetostrictive rod shown in FIG. 6(a) which is taken along a B-B line in FIG. 6(a).

FIG. 7(a) is a perspective view showing a flow of lines of magnetic force on the tip end side of the power generator shown in FIG. 1 (with the coils, a spacer, a connecting portion and female screw portions of second block bodies being omitted). FIG. 7(b) is a schematic view showing the flow of the lines of magnetic force passing through the second block bodies, permanent magnets and magnetic members of the power generator shown in FIG. 7(a).

FIG. 8 is a side view schematically showing a state that external force in the lower direction is applied to a tip end portion of one rod member (one beam) whose base end portion is fixed to a housing.

FIG. 9 is a side view schematically showing a state that external force in the lower direction is applied to tip end portions of a pair of beams (parallel beams) parallel arranged so as to face each other whose base end portions are fixed to the housing.

FIG. 10 is a view schematically showing stress (tensile stress and compressive stress) generated in the pair of parallel beams when the external force is applied to the tip end portions of the pair of parallel beams.

FIG. 11 is a graph showing a relationship between magnetic flux density (B) and a bias magnetic field (H) applied to a magnetostrictive rod formed of a magnetostrictive material containing an iron-gallium based alloy (having a Young's modulus of about 70 GPa) as a main component thereof depending on stress generated in the magnetostrictive rod.

FIG. 12 is a perspective view showing a configuration on the tip end side of another configuration example of the power generator of the first embodiment of the present invention (with the coils, the spacer, the connecting portion and the female screw portions of the second block bodies being omitted).

FIG. 13(a) is a planar view of the power generator shown in FIG. 12. FIG. 13(b) is a side view of the power generator shown in FIG. 12. FIG. 13(c) is a front view of the power generator shown in FIG. 12. FIG. 13(d) is a back view of the power generator shown in FIG. 12.

FIG. 14 is a perspective view showing a flow of the lines of magnetic force on the tip end side of a second embodiment of the power generator of the present invention (with the coils, the spacer, the connecting portion and the female screw portions of the second block body being omitted).

FIG. 15 is a graph showing variation of magnetic flux density along a longitudinal direction of each of the magnetostrictive rods caused when the stress is generated in the second block body of the power generator shown in FIG. 1 and the power generator shown in FIG. 14.

FIG. 16(a) is a planar view schematically showing each block body included in the power generator shown in FIG. 14. FIGS. 16(b) to 16(e) are planar views schematically showing other configuration examples of each block body included in the power generator shown in FIG. 14.

FIG. 17 is a perspective view showing a flow of the lines of magnetic force on the tip end side of another configuration example of the power generator of the second embodiment of the present invention (with the coils, the spacer, the connecting portion and the female screw portions of the second block bodies being omitted).

### DETAILED DESCRIPTION OF THE PREFERRED EMBODIMENTS

Hereinafter, description will be given to a power generator of the present invention with reference to preferred embodiments shown in the accompanying drawings.

### First Embodiment

First, description will be given to a first embodiment of the power generator of the present invention.

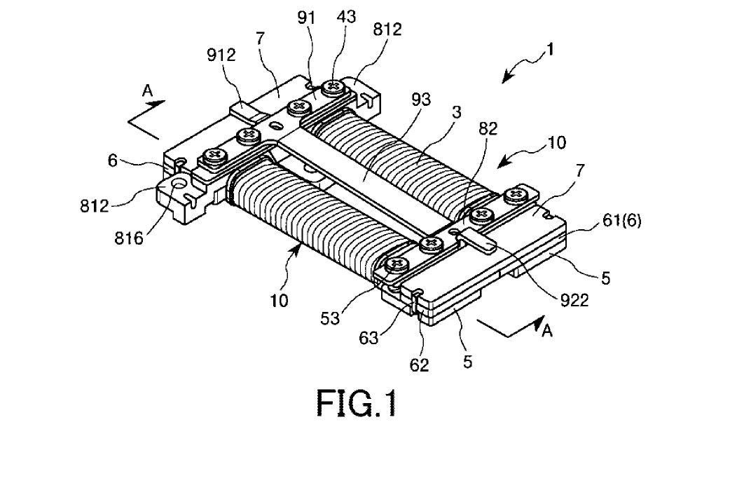

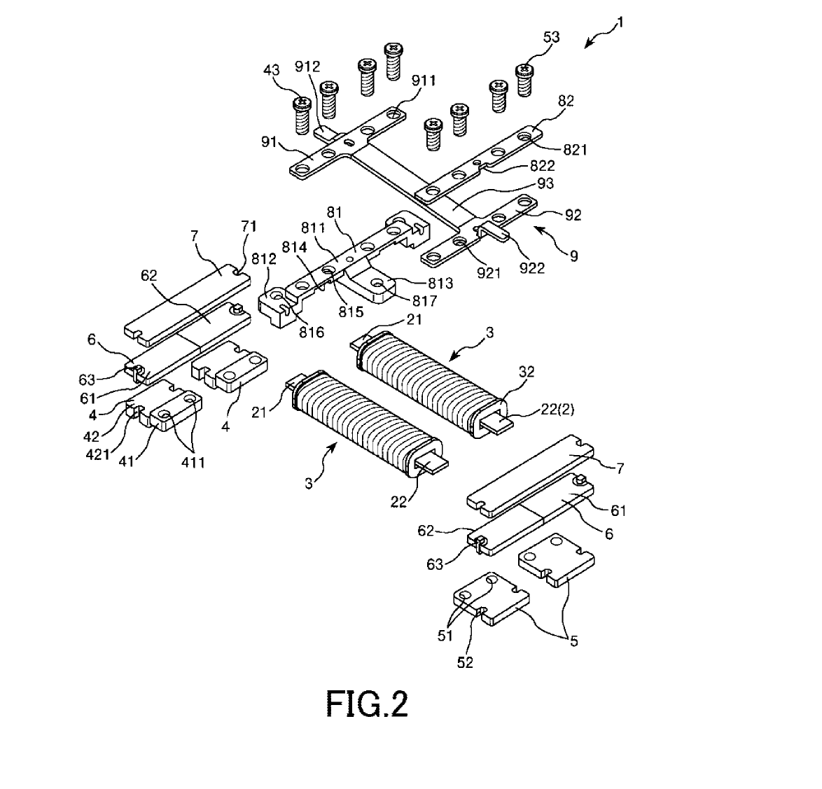

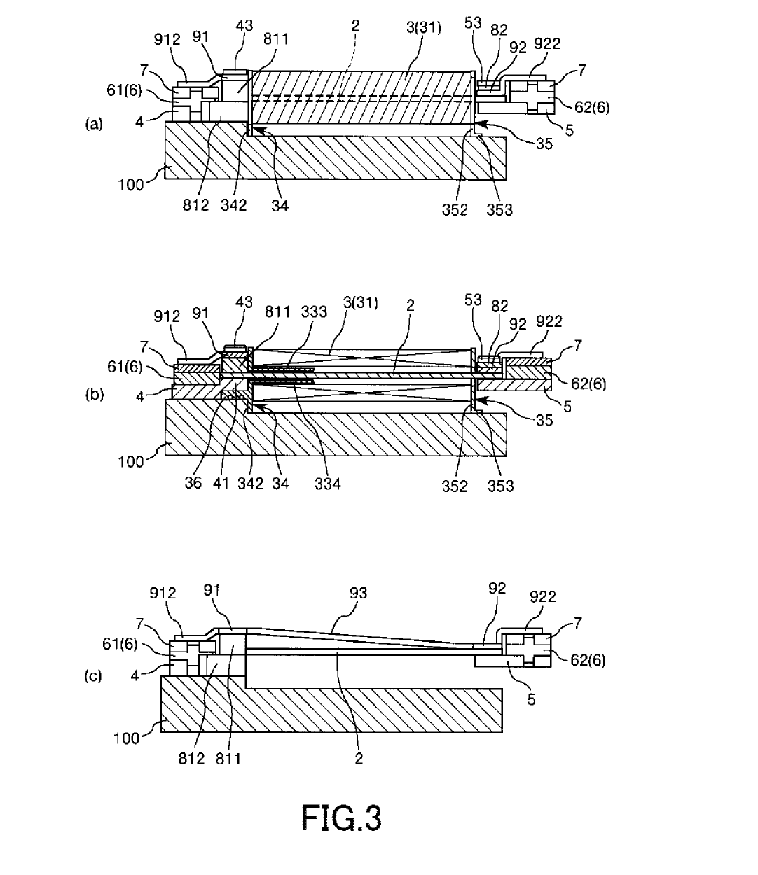

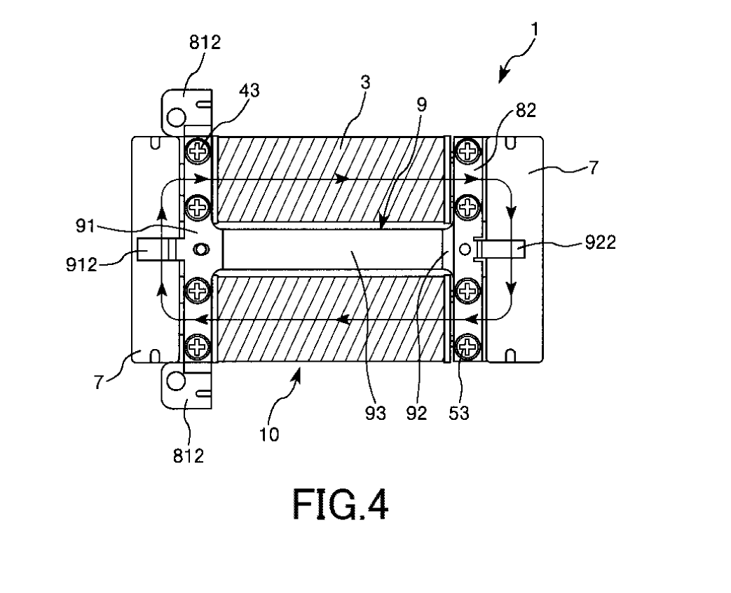

FIG. 1 is a perspective view showing the first embodiment of the power generator of the present invention. FIG. 2 is an exploded perspective view of the power generator shown in FIG. 1. FIG. 3(a) is a side view for explaining a state that the power generator shown in FIG. 1 is attached to a vibrating body. FIG. 3(b) is a longitudinal cross-sectional view (a cross-sectional view taken along an A-A line in FIG. 1) of the power generator shown in FIG. 1 which is attached to the vibrating body. FIG. 3(c) is a view showing a state that coils are removed from magnetostrictive elements shown in FIG. 3(a). FIG. 4 is a planar view of the power generator shown in FIG. 1.

Hereinafter, an upper side in each of FIGS. 1 to 3 and a front side of the paper in FIG. 4 are referred to as “upper” or “upper side” and a lower side in each of FIGS. 1 to 3 and a rear side of the paper in FIG. 4 are referred to as “lower” or “lower side”. Further, a right and front side of the paper in each of FIGS. 1 and 2 and a right side of each of FIGS. 3 and 4 are referred to as “tip end side” and a left and rear side of the paper in each of FIGS. 1 and 2 and a left side in each of FIGS. 3 and 4 are referred to as “base end side”.

The power generator 1 shown in FIGS. 1 and 2 includes two magnetostrictive elements 10 arranged side by side, a connecting portion 9 which is provided on the upper side of the magnetostrictive elements 10 and connects the magnetostrictive elements 10 with each other and permanent magnets 6 respectively provided on the base end side and the tip end side of the magnetostrictive elements 10. In this embodiment, this power generator 1 is fixed to a housing 100 of a vibrating body generating vibration.

Hereinafter, description will be given to each component of the power generator 1.

Each of the magnetostrictive elements 10 is formed of a magnetostrictive material. Each of the magnetostrictive elements 10 includes a magnetostrictive rod 2 through which lines of magnetic force pass in an axial direction thereof, a coil 3 wound around the magnetostrictive rod 2, a first block body 4 provided on the base end side of the magnetostrictive rod 2 and a second block body 5 provided on the tip end side of the magnetostrictive rod 2.

Each of the magnetostrictive elements 10 has one end portion on the side of the first block body 4 and the other end portion on the side of the second block body 5. Each of the magnetostrictive elements 10 is configured so that the other end portion can be relatively displaced with respect to the one end portion in a direction substantially perpendicular to an axial direction thereof (the vertical direction in FIG. 1) in a cantilevered state that the one end portion serves as a fixed end portion and the other end portion serves as a movable end portion. When the other end portion of the magnetostrictive element 10 is displaced with respect to the one end portion of the magnetostrictive element 10, the magnetostrictive rod 2 is deformed so as to be expanded and contracted. At this time, magnetic permeability of the magnetostrictive rod 2 varies due to an inverse magnetostrictive effect. This variation of the magnetic permeability of the magnetostrictive rod 2 leads to variation of density of the lines of magnetic force passing through the magnetostrictive rod 2 (density of the lines of magnetic force passing through the coil 3), thereby generating a voltage in the coil 3.

Hereinafter, description will be given to each component of each of the magnetostrictive elements 10 in detail.

The magnetostrictive rod 2 is formed of a magnetostrictive material and arranged so that a direction in which magnetization is easily generated (an easy magnetization direction) coincides with the axial direction thereof. In this embodiment, the magnetostrictive rod 2 has an elongated plate-like shape and arranged so that the lines of magnetic force pass through the magnetostrictive rod 2 in the axial direction thereof.

A base end portion (one end portion) 21 of the magnetostrictive rod 2 is attached (fixed) to the first block body 4 through the connecting portion 9. Further, a tip end portion 22 (the other end portion) of the magnetostrictive rod 2 is attached (fixed) to the second block body 5 through the connecting portion 9.

A thickness (cross-sectional area) of the magnetostrictive rod 2 is substantially constant along the axial direction thereof. An average thickness of the magnetostrictive rod 2 is not particularly limited to a specific value, but is preferably in the range of about 0.3 to 10 mm, and more preferably in the range of about 0.5 to 5 mm. Further, an average value of the cross-sectional area of the magnetostrictive rod 2 is preferably in the range of about 0.2 to 200 mm², and more preferably in the range of about 0.5 to 50 mm². With such a configuration, it is possible to reliably pass the lines of magnetic force through the magnetostrictive rod 2 in the axial direction thereof.

A Young's modulus of the magnetostrictive material is preferably in the range of about 40 to 100 GPa, more preferably in the range of about 50 to 90 GPa, and even more preferably in the range of about 60 to 80 GPa. By forming the magnetostrictive rod 2 with the magnetostrictive material having the above Young's modulus, it is possible to expand and contract the magnetostrictive rod 2 more drastically. Since this allows the magnetic permeability of the magnetostrictive rod 2 to vary more drastically, it is possible to more improve power generation efficiency of the power generator 1 (the coil 3).

The magnetostrictive material having the above Young's modulus is not particularly limited to a specific kind. Examples of such a magnetostrictive material include an iron-gallium based alloy, an iron-cobalt based alloy, an iron-nickel based alloy and a combination of two or more of these materials. Among them, a magnetostrictive material containing an iron-gallium based alloy (having a Young's modulus of about 70 GPa) as a main component thereof is preferably used. A Young's modulus of the magnetostrictive material containing the iron-gallium based alloy as the main component thereof can be easily adjusted to fall within the above range.

Further, it is preferable that the magnetostrictive material described above contains at least one of rare-earth metals such as Y, Pr, Sm, Tb, Dy, Ho, Er and Tm. By using the magnetostrictive material containing at least one rare-earth metal mentioned above, it is possible to more increase the variation of the magnetic permeability of each of the magnetostrictive rods 2.

The first block body 4 is provided on the base end side of the magnetostrictive rod 2.

The first block body 4 serves as a fixing portion for fixing the power generator 1 to the vibrating body generating the vibration. By fixing the power generator 1 to the vibrating body through the first block body 4, the magnetostrictive rod 2 is supported in a cantilevered state that the base end portion 21 thereof serves as a fixed end portion and the tip end portion 22 thereof serves as a movable end portion. Examples of the vibrating body to which the first block body 4 is attached include a variety of vibrating bodies such as a pump and an air-conditioning duct. Concrete examples of the vibrating body will be described later.

As shown in FIGS. 1 and 2, the first block body 4 has a tall block portion 41 provided on the tip end side and a short block portion 42 shorter (thinner) than this tall block portion 41. An external shape of the first block body 4 is a step-wise shape (multi-level shape).

The base end portion 21 of the magnetostrictive rod 2 is placed on the tall block portion 41 on the tip end side of the tall block portion 41. The first block body 4 is configured so that a bottom surface (lower surface) of the tall block portion 41 is located at a position higher than a position of a bottom surface (lower surface) of the short block portion 42. When the power generator 1 is attached to the housing 100 of the vibrating body, a protruding portion 36 of a bobbin 32 (which is described below) is inserted between the housing 100 and the bottom surface of the tall block portion 41. Further, a pair of female screw portions 411 are formed in both end portions of the tall block portion 41 in a width direction thereof so as to pass through the tall block portion 41 in a thickness direction thereof. Male screws 43 are respectively screwed with the female screw portions 411.

Further, cutout portions 421 are respectively formed on both side surfaces of the short block portion 42 in a width direction thereof so as to extend toward the central side of the short block portion 42.

On the other hand, the second block body 5 is provided on the tip end side of the magnetostrictive rod 2.

The second block body 5 serves as a weight for applying external force or vibration to the magnetostrictive rod 2. When the vibrating body vibrates, external force or vibration in the vertical direction is applied to the second block body 5. By applying the external force or the vibration to the second block body 5, the tip end portion 22 of the magnetostrictive rod 2 begins reciprocating motion in the vertical direction in the cantilevered state that the base end portion 21 of the magnetostrictive rod 2 serves as the fixed end portion and the tip end portion 22 of the magnetostrictive rod 2 serves as the movable end portion. Namely, the tip end portion 22 of the magnetostrictive rod 2 is relatively displaced with respect to the base end portion 21 of the magnetostrictive rod 2.

As shown in FIGS. 1 and 2, the second block body 5 has a substantially rectangular parallelepiped shape.

The tip end portion 22 of the magnetostrictive rod 2 is placed on the second block body 5 on the base end side of the second block body 5. Further, a pair of female screw portions 51 are formed in both end portions of the second block body 5 in a width direction thereof on the base end side thereof so as to pass through the second block body 5 in a thickness direction thereof. Male screws 53 are respectively screwed with the female screw portions 51. Further, cutout portions 52 are respectively formed on both side surfaces of the second block body 5 in the width direction thereof on the tip end side of thereof so as to extend toward the central side of the second block body 5.

A constituent material for each of the first block body 4 and the second block body 5 is not particularly limited to a specific kind as long as it has an enough stiffness for reliably generating uniform stress in the magnetostrictive rod 2 and enough ferromagnetism for applying a bias magnetic field generated from the permanent magnets 6 to the magnetostrictive rod 2. Examples of the constituent material having the above properties include a pure iron (e.g., “JIS SUY”), a soft iron, a carbon steel, a magnetic steel (silicon steel), a high-speed tool steel, a structural steel (e.g., “JIS SS400”), a stainless, a permalloy and a combination of two or more of these materials.

A width of each of the first block body 4 and the second block body 5 is designed so as to be larger than a width of the magnetostrictive rod 2. Specifically, each of the first block body 4 and the second block body 5 has a width which enables the magnetostrictive rod 2 to be arranged between the pairs of female screw portions 411, 51. The width of each block body 4, 5 as described above is preferably in the range of about 3 to 15 mm, and more preferably in the range of about 5 to 10 mm. By setting the width of each block body 4, 5 to fall within the above range, it is possible to downsize the power generator 1 and sufficiently ensure a size of the coil 3 wound around the magnetostrictive element 10. Further, if the width of each block body 4, 5 is in the above range, a square measure of a contacting surface between each of the permanent magnets 6 and each block body 4, 5 becomes sufficiently large as described below, thereby sufficiently increasing an intensity of the bias magnetic field applied to the magnetostrictive rod 2 from the permanent magnets 6 through each block body 4, 5.

Each of a distance (separation distance) between the first block bodies 4 of the magnetostrictive elements 10 and a distance (separation distance) between the second block bodies 5 of the magnetostrictive elements 10 is not particularly limited to a specific value, but is preferably in the range of about 1 to 15 mm, and more preferably in the range of about 3 to 10 mm.

The coil 3 is wound around an outer periphery of the magnetostrictive rod 2 (arranged on the outer peripheral side of the magnetostrictive rod 2) so as to surround a portion of the magnetostrictive rod 2 except for both end portions 21, 22 of the magnetostrictive rod 2.

The coil 3 includes the bobbin 32 arranged on the outer peripheral side of the magnetostrictive rod 2 so as to surround the magnetostrictive rod 2 and a wire 31 wound around the bobbin 32. With this configuration, the coil 3 is arranged so that the lines of magnetic force passing through the magnetostrictive rod 2 pass inside the coil 3 (an inner cavity of the coil 3) in an axial direction of the coil 3 (in this embodiment, the axial direction of the coil 3 is equivalent to the axial direction of the magnetostrictive rod 2). Due to the variation of the magnetic permeability of the magnetostrictive rod 2, that is, due to the variation of the density of the lines of magnetic force (magnetic flux density) passing through the magnetostrictive rod 2, the voltage is generated in the coil 3.

In the power generator 1 of this embodiment, the magnetostrictive elements 10 are arranged side by side in not a thickness direction thereof but a width direction thereof. Thus, it is possible to make a gap between the magnetostrictive elements 10 (a gap between the magnetostrictive rods 2) larger at the time of designing the power generator 1. Therefore, it is possible to sufficiently ensure spaces for the coils 3 (the wires 31 wound around the bobbins 32), and thereby it is possible to use the bobbins 32 each having a relatively large size in the power generator 1. Further, even if the wire 31 having a relatively large cross-sectional area (diameter) is wound around each of the bobbins 32 for forming each of the coils 3, it is possible to increase a winding number of the wire 31. Since the wire 31 having a large diameter has a small resistance value (small load impedance), it is possible to allow electric current to flow in the coils 3 efficiently, thereby efficiently utilizing the voltage generated in the coils 3.

The voltage ε generated in the coils 3 can be expressed by the following formula (1) based on the variation of the magnetic flux density of each of the magnetostrictive rods 2.

ε=N×ΔB/ΔT (1)
(wherein “N” is the winding number of the wire 31, “AB” is a variation amount of the magnetic flux passing in the inner cavities of the coils 3 and “ΔT” is a variation amount of time.)

As is clear from the above formula (1), the voltage ε generated in each of the coils 3 is proportional to the winding number of the wire 31 and the variation amount of the magnetic flux density of each of the magnetostrictive rods 2 (ΔB/ΔT). Thus, it is possible to improve the power generation efficiency of the power generator 1 by increasing the winding number of the wire 31.

The wire 31 is not particularly limited to a specific type. Examples of the wire 31 include a wire obtained by covering a copper base line with an insulating layer, a wire obtained by covering a copper base line with an insulating layer to which an adhesive (fusion) function is imparted and a combination of two or more of these wires.

The winding number of the wire 31 is not particularly limited to a specific value, but is preferably in the range of about 1000 to 10000, and more preferably in the range of about 2000 to 9000. With such a configuration, it is possible to more increase the voltage generated in each of the coils 3.

Further, the cross-sectional area of the wire 31 is not particularly limited to a specific value, but is preferably in the range of about 5×10⁻⁴ to 0.15 mm², and more preferably in the range of about 2×10⁻³ to 0.08 mm². Since the wire 31 with such a cross-sectional area of the above range has a sufficiently small resistance value, it is possible to efficiently output the electric current flowing in each of the coils 3 to the outside with the generated voltage. As a result, it is possible to more improve the power generation efficiency of the power generator 1.

A cross-sectional shape of the wire 31 may be any shape. Examples of the cross-sectional shape of the wire 31 include a polygonal shape such as a triangular shape, a square shape, a rectangular shape and a hexagonal shape; a circular shape and an elliptical shape.

Although this matter is not shown in the drawings, both end portions of the wire 31 of each of the coils 3 are connected to an electric circuit such as a wireless device (wireless communication device). With this configuration, it is possible to utilize the voltage (electric power) generated in the coils 3 for the electric circuit.

Next, description will be given to a configuration of the bobbin 32 around which the wire 31 is wound.

Each of FIGS. 5(a) and 5(b) is a perspective view showing the bobbin of each of the coils included in the power generator shown in FIG. 1. Each of FIGS. 6(a) and 6(b) is a perspective view showing the coil and the magnetostrictive rod included in the power generator shown in FIG. 1. FIG. 6(c) is a perspective view showing cross-sectional surfaces of the coil and the magnetostrictive rod shown in FIG. 6(a) which is taken along a B-B line in FIG. 6(a).

Hereinafter, an upper side in each of FIGS. 5(a), 5(b), 6(a), 6(b) and 6(c) is referred to as “upper” or “upper side” and a lower side in each of FIGS. 5(a), 5(b), 6(a), 6(b) and 6(c) is referred to as “lower” or “lower side”. FIG. 5(a) is illustrated so that the tip end side of the bobbin is directed toward a right and front side of the paper in FIG. 5(a). FIG. 5(b) is illustrated so that the base end side of the bobbin is directed toward a right and front side of the paper in FIG. 5(b). Each of FIGS. 6(a) and 6(c) is illustrated so that the tip end side of the magnetostrictive rod and the coil is directed toward a right and front side of the paper in each of FIGS. 6(a) and 6(c). FIG. 6(b) is illustrated so that the base end side of the magnetostrictive rod and the coil is directed to a right and front side of the paper in FIG. 6(b).

As shown in FIGS. 5(a) and 5(b), the bobbin 32 includes a longitudinal main body 33 around which the wire 31 is to be wound, a first flange portion 34 to be connected to a base end portion of the main body 33 and a second flange portion 35 to be connected to a tip end portion of the main body 33. In this regard, although the bobbin 32 as described above may take a configuration in which these components (the main body 33, the first flange portion 34 and the second flange portion 35) thereof are connected with each other with a welding method or the like, it is preferable that the components of the bobbin 32 are formed integrally with each other.

The main body 33 includes a pair of longitudinal side plate portions 331, 332, an upper plate portion 333 provided on the base end side of the main body 33 and connecting upper end portions of the side plate portions 331, 332 with each other and a lower plate portion 334 provided on the base end side of the main body 33 and connecting lower end portions of the side plate portions 331, 332 with each other. Each of the side plate portions 331, 332, the upper plate portion 333 and the lower plate portion 334 has a plate-like shape.

The main body 33 has a rectangular parallelepiped portion defined by the side plate portions 331, 332, the upper plate portion 333 and the lower plate portion 334 on the base end side thereof. The magnetostrictive rod 2 is inserted into an inside of the rectangular parallelepiped portion.

A distance (space) between the side plate portions 331, 332 is adjusted so as to be larger than the width of the magnetostrictive rod 2. The magnetostrictive rod 2 is arranged between the side plate portions 331, 332 in a state that the magnetostrictive rod 2 is spaced apart from the side plate portions 331, 332. Further, a distance (space) between the upper plate portion 333 and the lower plate portion 334 is adjusted so as to be substantially equal to the thickness of the magnetostrictive rod 2. The magnetostrictive rod 2 is inserted between the upper plate portion 333 and the lower plate portion 334 so that a part of the base end portion 21 of the magnetostrictive rod 2 is gripped between the upper plate portion 333 and the lower plate portion 334 (see FIG. 6(c)).

Further, the wire 31 is wound around an outer peripheral portion of the main body 33 from the base end side to the tip end side of the main body 33.

The plate-like first flange portion 34 to be connected with the main body 33 (the side plate portions 331, 332, the upper plate portion 333 and the lower plate portion 334) is provided on the base end side of the main body 33 (see FIG. 5(b)).

The first flange portion 34 is formed into a substantially elliptical shape. In the first flange portion 34, a slit 341 into which the magnetostrictive rod 2 is to be inserted is formed at a position where the first flange portion 34 is connected with the main body 33. The slit 341 has the substantially same shape as the cross-sectional surface of the magnetostrictive rod 2.

Further, a lower end portion 342 of the first flange portion 34 is configured so as to make contact with the vibrating body when the power generator 1 is attached to the housing 100 of the vibrating body.

Further, the first flange portion 34 has the protruding portion 36 protruding from the first flange portion toward the base end side of the main body 33. The protruding portion 36 is provided on the lower side of the slit 341. In the power generator 1 of this embodiment, the bobbin 32 is attached to the magnetostrictive element 10 so that an upper part on the upper side of the protruding portion 36 of the first flange portion 34 makes contact with a tip end surface of the first block body 4 (the tall block portion 41) and the protruding portion 36 makes contact with a lower surface of the first block body 4. Two grooves 361 are formed on a lower surface of the protruding portion 36 so as to extend along a width direction of the protruding portion 36. Although this matter is not shown in the drawings, in the case where two protruding portions corresponding to the two grooves 361 are formed on the vibrating body to which the power generator 1 is attached, by engaging the two protruding portions of the vibrating body with the two grooves 361 of the power generator 1 (the protruding portion 36), it is possible to easily arrange the power generator 1 at a prescribed position on the vibrating body. Namely, it is possible to easily position the power generator 1 with respect to the vibrating body.

The plate-like second flange portion 35 to be connected with the main body 33 (the side plate portions 331, 332) is provided on the tip end side of the main body 33 (see FIG. 5(a)).

The second flange portion 35 is formed into a substantially elliptical shape. In the second flange portion 35, an opening 351 in which the magnetostrictive rod 2 is to be inserted is formed at a position where the second flange portion 35 is connected with the main body 33 (the side plate portions 331, 332). The opening 351 has a substantially quadrangular shape. A width of the opening 351 is substantially equal to the distance between the side plate portions 331, 332. Further, a distance from an upper end portion to a lower end portion of the opening 351 is adjusted so as to be substantially equal to a length of each of the side plate portions 331, 332 in a width direction (a short direction).

A lower end portion 352 of the second flange portion 35 is configured so as to make contact with the housing 100 of the vibrating body when the power generator 1 is attached to the housing 100 of the vibrating body. Further, two protruding portions 353 protruding toward the tip end side of the bobbin 32 are respectively provided on both end portions in a width direction of the lower end portion 352. The lower end portion 352 and the two protruding portions 353 support the bobbin 32 with respect to the housing 100 of the vibrating body in cooperation with the lower end portion 342 of the first flange portion 34.

The second flange portion 35 is spaced apart from the second block body 5 in a state that the bobbin 32 is attached to the magnetostrictive element 10.

As shown in FIG. 3(b), in the power generator 1 of this embodiment, a gap is formed between the magnetostrictive rod 2 and the bobbin 32 (or the wire 31) in the displacement (vibrating) direction of the magnetostrictive rod 2 (the vertical direction in FIG. 3(b)) from a vicinity of center of the bobbin 32 to the tip end side of the bobbin 32. The gap is formed so as to have a size for preventing the magnetostrictive rod 2 and the bobbin 32 (or the wire 31) from interfering with each other when the magnetostrictive rod 2 is displaced by the vibration of the vibrating body. Namely, the gap is formed so that the size of the gap becomes larger than amplitude of the vibration of the magnetostrictive rod 2. Thus, it is possible to vibrate the magnetostrictive rod 2 without the magnetostrictive rod 2 making contact with the coil 3 (the wire 31 and the bobbin 32). In such a configuration, it is possible to prevent occurrence of energy loss caused by friction between the magnetostrictive rod 2 and coil 3.

Further, in the power generator 1 of this embodiment, when the magnetostrictive rod 2 (the magnetostrictive element 10) and a beam member 93 are deformed, the coil 3 (the wire 31 and the bobbin 32) is not deformed together with the deformation of the magnetostrictive rod 2 and the beam member 93. Generally, an amount of energy loss caused by deformation of a wire and a bobbin forming a coil is large. Namely, each of the wire and the bobbin has a high loss coefficient. Thus, in the power generator 1 of this embodiment, it is possible to prevent occurrence of energy loss (structural attenuation) caused by deformation of the wire 31 and the bobbin 32 each having the high loss coefficient. Further, in the power generator 1 of this embodiment, the coil 3 having large mass is not deformed by the vibration of the magnetostrictive rod 2. Namely, mass of the coil 3 is not included in total mass of a vibration system for vibrating the magnetostrictive rod 2. Therefore, in the power generator 1 of this embodiment, it is possible to prevent a vibration frequency of the magnetostrictive rod 2 (the vibration system) from being lowered in comparison with a power generator in which a coil is deformed together with a magnetostrictive rod. This makes it possible to prevent the variation amount of the magnetic flux density in the magnetostrictive rod 2 per unit time (a change gradient of the magnetic flux density) from decreasing, thereby improving the power generating efficiency of the power generator 1.

As described above, according to the power generator 1, it is possible to prevent the occurrence of energy loss caused by the friction between the magnetostrictive rod 2 and the coil 3 and the occurrence of energy loss caused by the deformation of the coil 3 having the high loss coefficient. Further, it is possible to prevent the vibration frequency of the magnetostrictive rod 2 (the vibration system) from being lowered due to the deformation of the coil 3 having the large mass. Thus, in the power generator 1 of this embodiment, the vibration of the vibrating body is effectively utilized to deform the magnetostrictive rod 2 (the magnetostrictive element 10), thereby improving the power generating efficiency of the power generator 1.

Further, by changing the length of each of the side plate portions 331, 332 in the width direction (a short direction) thereof and adjusting the distance from the upper end portion to the lower end portion of the opening 351 as the length of each of the side plate portions 331, 332 is changed, it is possible to freely adjust the size of the gap between the magnetostrictive rod 2 and the bobbin 32 depending on the amplitude of the vibration of the magnetostrictive rod 2.

As a constituent material for the bobbin 32, it is possible to use a weakly magnetic material or a non-magnetic material.

The two permanent magnets 6 for applying the bias magnetic field to the magnetostrictive rods 2 are respectively provided on upper surfaces of the first block bodies 4 and upper surfaces of the second block bodies 5 of the magnetostrictive elements 10.

Each of the permanent magnets 6 has an elongated plate-like shape. As shown in FIGS. 1 and 2, one of the two permanent magnets 6 connects the first block bodies 4 with each other so as to cover upper surfaces of the short block portions 42 of the first block bodies 4. On the other hand, the other of the two permanent magnets 6 connects the second block bodies 5 with each other so as to cover areas of the upper surfaces of the second block bodies 5 on the tip end side of the second block bodies 5.

The permanent magnet 6 connecting the first block bodies 4 with each other includes a first portion 61 to be provided on the first block body 4 of the magnetostrictive element 10 arranged on the lower side in FIG. 4 and a second portion 62 to be provided on the first block body 4 of the magnetostrictive element 10 arranged on the upper side in FIG. 4. The first portion 61 is formed so that its north pole is directed toward the front side of the paper in FIG. 4 and its south pole is directed toward the rear side of the paper in FIG. 4. The second portion 62 is formed so that its south pole is directed toward the front side of the paper in FIG. 4 and its north pole is directed toward the rear side of the paper in FIG. 4. Namely, the permanent magnet 6 connecting the first block bodies 4 with each other is a dipole magnet including the first portion 61 magnetized in a direction (a first magnetization direction) perpendicular to the arrangement direction of the magnetostrictive elements 10 and the second portion 62 magnetized in a direction (a second magnetization direction) opposed to the first magnetization direction of the first portion 61. In this embodiment, each of the first magnetization direction and the second magnetization direction of the permanent magnet 6 is parallel to the displacement direction of the other end portion of each of the magnetostrictive elements 10 (the vertical direction in FIG. 1).

The permanent magnet 6 connecting the second block bodies 5 with each other includes a second portion 62 to be provided on the second block body 5 of the magnetostrictive element 10 arranged on the lower side in FIG. 4 and a first portion 61 to be provided on the second block body 5 of the magnetostrictive element 10 arranged on the upper side in FIG. 4. As described above, the second portion 62 is formed so that its south pole is directed toward the front side of the paper in FIG. 4 and its north pole is directed toward the rear side of the paper in FIG. 4. The first portion 61 is formed so that its north pole is directed toward the front side of the paper in FIG. 4 and its south pole is directed toward the rear side of the paper in FIG. 4. The permanent magnet 6 connecting the second block bodies 5 with each other is also the same dipole magnet as the permanent magnet 6 connecting the first block bodies 4 with each other.

As described above, in the power generator 1 of this embodiment, the permanent magnets 6 are arranged so that each of the magnetization directions of the permanent magnets differs from the arrangement direction of the two magnetostrictive elements 10 arranged side by side.

It is assumed that permanent magnets are arranged so that each of magnetization directions of the permanent magnets coincides with an arrangement direction of two magnetostrictive elements arranged side by side. In this case, it is required to respectively arrange the permanent magnets between tip end portions of the two magnetostrictive elements and between base end portions of the two magnetostrictive elements or it is required to arrange one of the permanent magnets between the tip end portions of the two magnetostrictive elements or between the base end portions of the two magnetostrictive elements in order to apply a sufficient bias magnetic field to magnetostrictive rods. In this configuration, when trying to suppress increasing of a size of a power generator, a square measure of a contacting surface between the permanent magnet and the magnetostrictive element is limited.

In contrast, according to the power generator 1, it is possible to reduce the limitation about the square measure of the contacting surface between each of the permanent magnets 6 and each of the magnetostrictive elements 10 (each block body 4, 5), thereby freely designing the power generator 1.

Further, in the power generator 1 of this embodiment, the two permanent magnets 6 are respectively arranged on the upper surfaces of the first block bodies 4 and the upper surfaces of the second block bodies 5 as shown in FIGS. 1 and 2, but the present invention is not limited thereto. For example, it is possible to take a configuration in which the permanent magnet 6 is fixed to end surfaces of the first block bodies 4 on the tip end of the first block bodies 4 instead of arranging the permanent magnet 6 on the upper surfaces of the first block bodies 4. Further, by increasing the square measure of the contacting surface between the permanent magnet 6 and each of the magnetostrictive elements 10, it is possible to apply the sufficient bias magnetic field to the magnetostrictive rods 2 even if one of the two permanent magnets 6 is omitted.

Thus, according to the present invention, it is possible to freely design the square measure of the contacting surface between each of the permanent magnets 6 and each of the magnetostrictive elements 10, an arrangement position of each of the permanent magnets 6 and an arranged number of the permanent magnets 6. Namely, it is possible to improve the degree of freedom for design of the permanent magnets 6 used in the power generator 1.

As the permanent magnet 6, it is possible to use an alnico magnet, a ferrite magnet, a neodymium magnet, a samarium-cobalt magnet, a magnet (a bonded magnet) obtained by molding a composite material prepared by pulverizing and mixing at least one of these magnets with a resin material or a rubber material, or the like. It is preferable that the permanent magnet 6 as described above is fixed to each block body 4, 5 with a bonding method with an adhesive agent or the like.

Magnetic members 7 are respectively provided on upper surfaces of the permanent magnets 6.

Each of the magnetic members 7 has an elongated plate-like shape and formed into the substantially same shape as each of the permanent magnets 6. A constituent material for the magnetic members 7 may be the same constituent material for each block body 4, 5.

Cutout portions 71 are respectively formed on both end surfaces of the magnetic member 7 in a longitudinal direction thereof so as to extend toward the central side of the magnetic member 7. In the power generator 1 of this embodiment, protruding portions 63 of the permanent magnet 6 provided on the first block bodies 4 are engaged with the cutout portions 71 of the magnetic member 7 (which is provided on the side of the first block bodies 4) on the upper side of the permanent magnet 6 and the cutout portions 421 of the first block bodies 4 (which are provided on the outer sides of the first block bodies 4) on the lower side of the permanent magnet 6. Further, these components (the first block bodies 4, the permanent magnet 6 and the magnetic member 7) are fixed to each other by an adhesive agent. With this configuration, the permanent magnet 6 and the magnetic member 7 are attached to the first block bodies 4. Further, protruding portions 63 of the permanent magnet 6 provided on the second block bodies 5 are engaged with the cutout portions 71 of the magnetic member 7 (which is provided on the side of the second block bodies 5) on the upper side of the permanent magnet 6 and the cutout portions 421 of the second block bodies 5 (which are provided on the outer sides of the second block bodies 5) on the lower side of the permanent magnet 6. Further, these components (the second block bodies 5, the permanent magnet 6 and the magnetic member 7) are fixed to each other by an adhesive agent. With this configuration, the permanent magnet 6 and the magnetic member 7 are attached to the second block bodies 5.

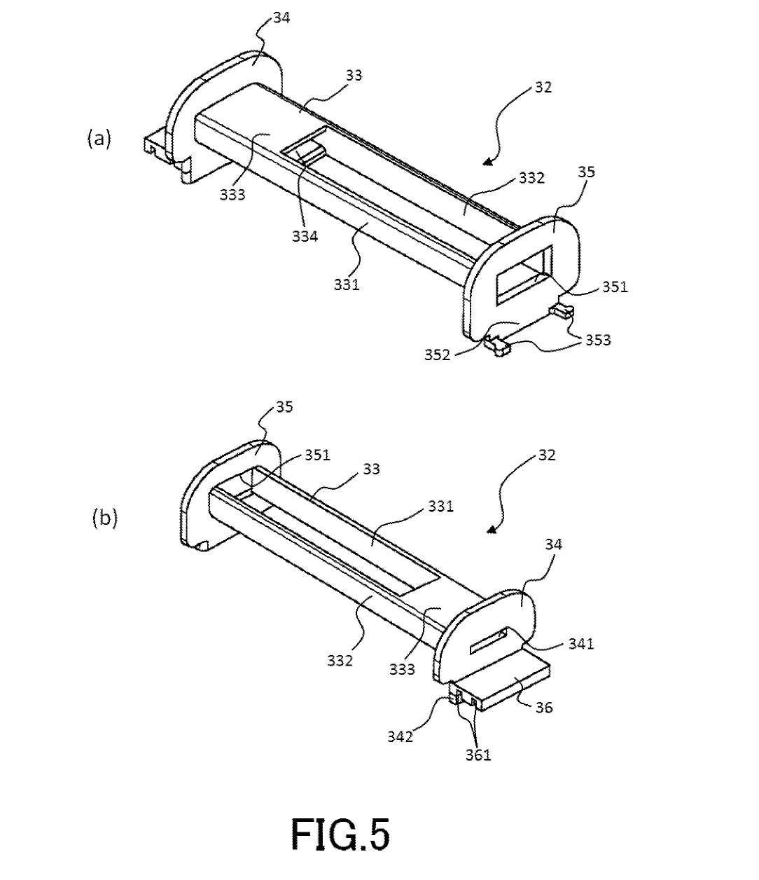

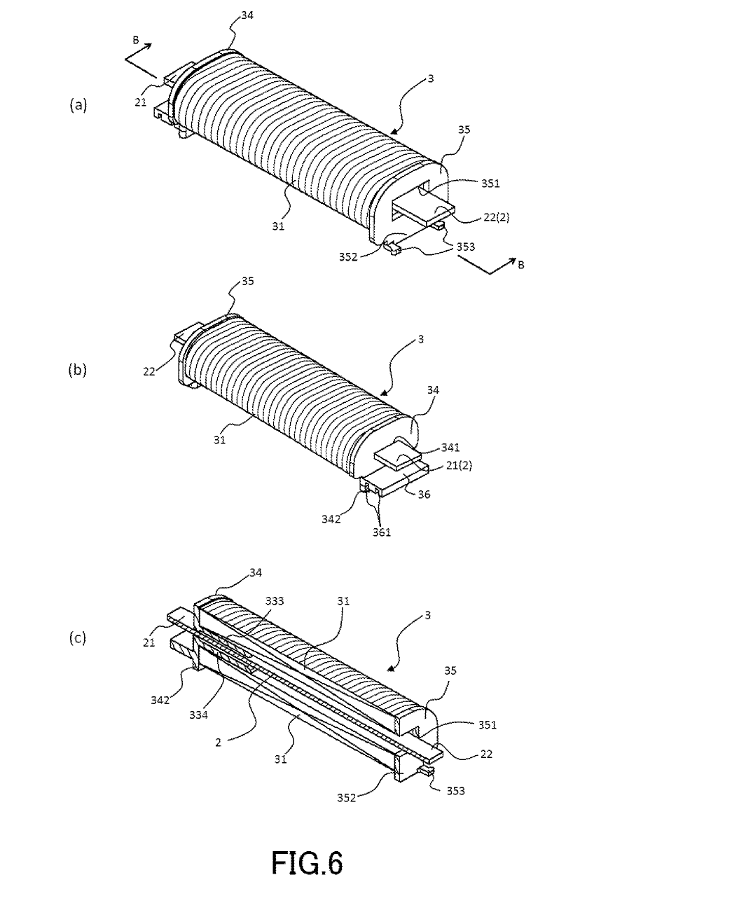

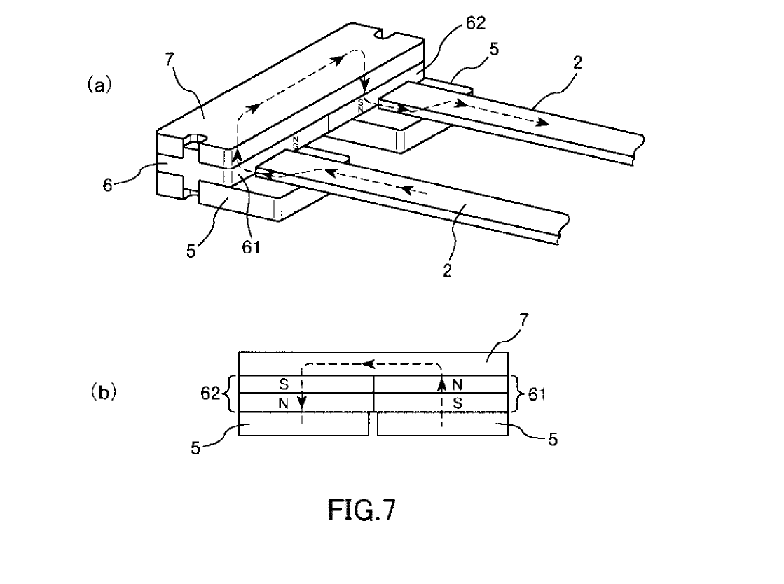

Here, description will be given to a flow of the lines of magnetic force passing through each component of the power generator 1 with reference to FIGS. 4 and 7.

FIG. 7(a) is a perspective view showing the flow of the lines of magnetic force on the tip end side of the power generator shown in FIG. 1 (with the coils, a spacer, the connecting portion and the female screw portions of the second block bodies being omitted). FIG. 7(b) is a schematic view showing the flow of the lines of magnetic force passing through the second block bodies, the permanent magnets and the magnetic members of the power generator shown in FIG. 7(a).

Hereinafter, an upper side in each of FIGS. 7(a) and 7(b) is referred to as “upper” or “upper side” and a lower side in each of FIGS. 7(a) and 7(b) is referred to as “lower” or “lower side”.

With referring to FIG. 4, in the power generator 1, lines of magnetic force generated from the first portion 61 of the permanent magnet 6 provided on the base end side flows into the second portion 62 of the permanent magnet 6 provided on the base end side through the magnetic member 7. On the other hand, lines of magnetic force generated from the second portion 62 of the permanent magnet 6 provided on the base end side flows into the first portion 61 of the permanent magnet 6 provided on the tip end side through the magnetostrictive element 10 (the first block body 4, the magnetostrictive rod 2 and the second block body 5) arranged on the upper side in FIG. 4. Further, lines of magnetic force generated from the first portion 61 of the permanent magnet 6 provided on the tip end side flow into the second portion 62 of the permanent magnet 6 provided on the tip end side through the magnetic member 7. On the other hand, lines of magnetic force generated from the second portion 62 of the permanent magnet 6 provided on the tip end side flow into the first portion 61 of the permanent magnet 6 provided on the base end side through the magnetostrictive element 10 (the second block body 5, the magnetostrictive rod 2 and the first block body 4) arranged on the lower side in FIG. 4.

Among the above flows of the lines of magnetic forces on the base end side and the tip end side of the power generator 1, the flows of the lines of magnetic force on the tip end side of the power generator 1 are illustrated in FIGS. 7(a) and 7(b). In this regard, the flows of the lines of magnetic force on the base end side of the power generator 1 are same as the flows of the lines of magnetic forces on the tip end side of the power generator 1.

On the tip end side of the power generator 1, the lines of magnetic force passing through the magnetostrictive rod 2 arranged on the front side of the paper in FIG. 7(a) from the base end side to the tip end side of the magnetostrictive rod 2 flow into the first portion 61 of the permanent magnet 6 through the second block body 5 provided on the front side of the paper in FIG. 7(a). Further, the lines of magnetic force generated from the first portion 61 of the permanent magnet 6 flow into the second portion 62 of the permanent magnet 6 passing through the magnetic member 7 in the longitudinal direction of the magnetic member 7 (see FIG. 7(b)). Furthermore, the lines of magnetic force generated from the second portion 62 of the permanent magnet 6 pass through the second block body 5 provided on the rear side of the paper in FIG. 7(a) and then flow in the magnetostrictive rod 2 arranged on the rear side of the paper in FIG. 7(a) from the tip end side to the base end side of the magnetostrictive rod 2.

As described above, in the power generator 1 of this embodiment, the lines of magnetic force generated from the first portion 61 of each of the permanent magnets 6 flow into the second portion 62 of each of the permanent magnets 6 through each magnetic member 7 and the lines of magnetic force generated from the second portion 62 of each of the permanent magnets 6 flow into the first portion 61 of each of the permanent magnets 6 through each magnetostrictive element 10. With this configuration, a magnetic field loop circulating in the clockwise direction is formed in the power generator 1.

In the power generator 1 of this embodiment, from a point of view of reducing the entire size of the power generator 1 or making the thickness of the power generator 1 smaller (thinner), it is preferable to reduce a height (thickness) of each block body 4, 5. In this case, although a surface area of a side surface of each block body 4, 5 becomes small, it is possible to relatively sufficiently ensure a surface area of the upper surface of each block body 4, 5. In the power generator 1, by respectively arranging the plate-like permanent magnets 6 on the upper surfaces of the block bodies 4, 5, it is possible to sufficiently increase a square measure of a contacting surface between each of the permanent magnets 6 (the first portions 61 and the second portions 62) and each of the block bodies 4, 5. With this configuration, it is possible to apply a larger bias magnetic field to the magnetostrictive rods 2, thereby improving the power generation efficiency of the power generator 1 with suppressing the increasing of the size of the power generator 1.

Further, even in the case of using a ferrite magnet or the like having inferior characteristics such as attracting force or a maximum energy product as compared with a rare-earth magnet as each of the permanent magnets 6, it is possible to apply a sufficiently large bias magnetic field to the magnetostrictive rods 2. Since the ferrite magnet or the like is not expensive, by using the ferrite magnet as each of the permanent magnets 6, it is possible to suppress a manufacturing cost of the power generator 1.

A square measure of a surface (lower surface) of each permanent magnet 6 to be contacting with each block body 4, 5 is not particularly limited to a specific value, but is preferably in the range of about 10 to 300 mm², and more preferably in the range of about 20 to 100 mm².

Further, it is preferable that a square measure of a surface (lower surface) of each of the first portion 61 and the second portion 62 of each permanent magnet 6 to be contacting with each block body 4, 5 is set so that the permanent magnets 6 can completely cover the upper surfaces of the short block portions 42 of the first block bodies 4 and the areas of the upper surfaces of the second block bodies 5 on the tip end side of the second block bodies 5. With this configuration, it is possible to apply a larger bias magnetic field to the magnetostrictive rods 2. As a result, it is possible to more improve the power generation efficiency of the power generator 1 with suppressing the increasing of the size of the power generator 1.

The magnetostrictive elements 10 as described above are connected with each other by the connecting portion 9 through spacers 81, 82.

The spacer 81 is formed of a weakly magnetic material or a non-magnetic material. The spacer 81 is placed on the tall block portions 41 of the two first block bodies 4 in a state that the base end portions 21 of the magnetostrictive rods 2 are placed on the tall block portions 41 of the first block bodies 4.

This spacer 81 includes a plate portion 811 having a belt-like shape (elongated plate-like shape), a pair of first bracket portions 812 protruding from both end portions of the plate portion 811 in a longitudinal direction of the plate portion 811 toward the longitudinal direction of the plate portion 811 and a second bracket portion 813 protruding from a substantially central portion of the plate portion 811 toward the tip end side. In this regard, the spacer 81 may take a configuration in which these components (the plate portion 811, the first bracket portions 812 and the second bracket portion 813) thereof are connected with each other with a welding method or the like, it is preferable that the components of the spacer 81 are formed integrally with each other.

The plate portion 811 includes two concave portions 814 formed on a bottom surface of the plate portion 811 at positions corresponding to the base end portions 21 of the two magnetostrictive rods 2. Further, the plate portion 811 includes four through-holes 815 formed at four positions respectively corresponding to the four female screw portions 411 formed in the two first block bodies 4 (the tall block portions 41). The male screws 43 are respectively inserted into the through-holes 815.

The first bracket portions 812 are respectively arranged on the outer sides of the two block bodies 4 (the tall block portions 41) and the lower side of the plate portion 811. When the power generator 1 is attached to the vibrating body, the first bracket portions 812 and the two first block bodies 4 make contact with the housing 100 of the vibrating body. Further, female screw portions 816 are respectively formed in substantially central portions of the first bracket portions 812 so as to pass through the first bracket portions 812 in a thickness direction thereof. By screwing male screws (not shown in the drawings) with the housing 100 through the female screw portions 816, it is possible to fix the first block bodies 4 to the housing 100.

The second bracket portion 813 extends from the substantially central portion of the plate portion 811 toward the lower side. When the power generator 1 is attached to the vibrating body, a part of the second bracket portion 813, the two first block bodies 4 and the first bracket portions 812 make contact with the housing 100. Further, a female screw portion 817 is formed in a substantially central portion of the second bracket portion 813 so as to pass through the second bracket portion 813 in a thickness direction thereof. By screwing a male screw (not shown in the drawings) with the housing 100 through the female screw portion 817, it is possible to fix the first block bodies 4 and the first bracket portions 812 to the housing 100. Although only the first bracket portions 812 are fixed to the housing 100 through the male screws in the power generator 1 of this embodiment, it may be possible to take a configuration in which the first bracket portions 812 and the second bracket portion 813 are fixed to the housing 100 depending on a shape of the housing 100.

The spacer 82 is formed of a weakly magnetic material or a non-magnetic material. The spacer 82 is placed on an upper surface of a second connecting member 92 of the connecting portion 9 described below.

The spacer 82 has a belt-like shape. The spacer 82 includes four through-holes 821 formed at four positions respectively corresponding to the four female screw portions 51 formed in the two second block bodies 5. The male screws are respectively inserted into the through-holes 821. Further, a cutout portion 822 is formed in a substantially central portion of the spacer 82 on the tip end side so as to extend toward the central side of the spacer 82. As described below, the cutout portion 822 is formed so that the spacer 82 and a piece portion 922 provided on the tip end side of the second connecting member 92 do not interfere with each other when the spacer 82 is placed on the second connecting member 92.

The connecting portion 9 includes a first connecting member 91 for connecting the first block bodies 4 of the magnetostrictive elements 10 with each other in cooperation with the spacer 81, the second connecting member 92 for connecting the second block bodies 5 with each other in cooperation with the spacer 82 and the one beam member 93 for connecting the first connecting member 91 and the second connecting member 92. The connecting portion 9 is formed of a weakly magnetic material or a non-magnetic material as is the case for the spacers 81, 82.

In this embodiment, each of the first connecting member 91, the second connecting member 92 and the beam member 93 has a belt-like shape. The connecting portion 9 has an H-like shape in a planar view as a whole. Although the connecting portion 9 may take a configuration in which these members (the first connecting member 91, the second connecting member 92 and the beam member 93) are connected with each other with a welding method or the like, it is preferable that the connecting portion 9 takes a configuration in which the members are formed integrally with each other.

The connecting portion 9 is configured so that the first connecting member 91 is placed on the plate portion 811 of the spacer 81 placed on the tall block portions 41 of the first block bodies 4 and the second connecting member 92 is placed on the base end portions of the second block bodies 5 through the tip end portions 22 of the magnetostrictive rods 2.

As shown in FIG. 3(c), in the power generator 1 of this embodiment, the connecting portion 9 is configured so that an arrangement position of the first connecting member 91 is higher than an arrangement position of the second connecting member 92 by a thickness of the plate portion 811 of the spacer 81 in the side view. Thus, the power generator is configured so that a separation distance between the magnetostrictive rods 2 and the first connecting member 91 is longer than a separation distance between the magnetostrictive rods 2 and the second connecting member 92. With this configuration, a gap between the magnetostrictive rods 2 and the beam member 93 connecting the first connecting member 91 and the second connecting member 92 decreases from the base end side to the tip end side in the side view.

For example, the connecting portion 9 having such a configuration can be obtained by preparing a plate material having an H-shaped in a planar view thereof and then bending the plate material with a press work, a bending work, a hammering work or the like so that the first connecting member 91 and the second connecting member 92 are bent from the beam member 93 respectively in two directions opposite to each other. By using such a method for obtaining the connecting portion 9, it is possible to easily and arbitrarily adjust an angle formed by the first connecting member 91 and the beam member 93 and an angle formed by the second connecting member 92 and the beam member 93.

The first connecting member 91 includes four through-holes 911 formed at four positions respectively corresponding to the four female screw portions 411 formed in the two first block bodies 4. The base end portions 21 of the magnetostrictive rods 2 are placed on the tall block portions 41 of the first block bodies 4 and the plate portion 811 of the spacer 81 is placed on the tall block portions 41 of the first block bodies 4 so that the base end portions 21 of the magnetostrictive rods 2 are received in the concave portions 814 of the spacer 81. Then, the male screws 43 are screwed with the female screw portions 411 passing through the through-holes 911 and the through-holes 815 of the spacer 81 in a state that the first connecting member 91 makes contact with the spacer 81 (the plate portion 811). With this configuration, the first connecting member 91 is screw-fixed to the first block bodies 4 and the base end portions 21 of the magnetostrictive rods 2 are gripped between the spacer 81 and the first block bodies 4. As a result, the base end portions 21 (the magnetostrictive rods 2) are fixed to the first block bodies 4.

The second connecting member 92 includes four through-holes 921 formed at four positions respectively corresponding to the four female screw portions 51 formed in the two second block bodies 5. The tip end portions 22 of the magnetostrictive rods 2 are placed on the base end portions of the second block bodies 5 and the second connecting member 92 is placed on the tip end portions 22 of the magnetostrictive rods 2 so as to make contact with the tip end portions 22 of the magnetostrictive rods 2. Then, the male screws 53 are screwed with the female screw portions 51 passing through the through-holes 921 and the through-holes 821 of the spacer 81 in a state that the spacer 82 is placed on the second connecting member 92. With this configuration, the second connecting member 92 is screw-fixed to the second block bodies 5 and the tip end portions 22 of the magnetostrictive rods 2 are gripped between the second connecting member 92 and the second block bodies 5. As a result, the tip end portions 22 (the magnetostrictive rods 2) are fixed to the second block bodies 5.

As described above, the magnetostrictive rods 2 and the first connecting member 91 are fastened to the first block bodies 4 with the male screws 43, and the magnetostrictive rods 2 and the second connecting member 92 are fastened to the second block bodies 5 with the male screws 53. Thus, it is possible to reduce the number of parts and the number of steps for fixing and connecting the members with each other. In this regard, a fixing and connecting method is not limited to the above screwing method. Examples of the fixing and connecting method include a bonding method with an adhesive agent, a brazing method and a welding method (such as a laser welding method and an electric welding method).

Further, in the power generator 1, the first block bodies 4 are connected and fixed with each other by the first connecting member 91 and the permanent magnet 6 and the second block bodies 5 are connected and fixed with each other by the second connecting member 92 and the permanent magnet 6. Thus, it is possible to sufficiently improve durability of the power generator 1. Further, compared with a power generator in which the first block bodies 4 are connected with each other only by the first connecting member 91 and the second block bodies 5 are connected with each other only by the second connecting member 92, it is possible to reduce a thickness and a width of each connecting member 91, 92. This makes it possible to reduce a weight of the connecting portion 9 and easily downsize the power generator 1.

By adjusting lengths of the first connecting member and the second connecting member 92, it is possible to change the gap between the magnetostrictive rods 2. By enlarging the gap between the magnetostrictive rods 2, it is possible to sufficiently ensure the spaces for respectively winding the coils 3 around the magnetostrictive rods 2. With this configuration, it is possible to sufficiently enlarge the sizes of the coils 3, thereby improving the power generation efficiency of the power generator 1.

Further, a protruding portion 912 is provided on the first connecting member 91 so as to extend from a side surface of a substantially central portion of the first connecting member 91 on the side opposite to the beam member 93 toward the base end side. When the first connecting member 91 is screw-fixed to the first block bodies 4, the protruding portion 912 makes contact with the magnetic member 7 arranged on the first block bodies 4. With this configuration, it is possible to screw-fix the first connecting member 91 to the first block bodies 4 in a state that the first connecting member 91 is stably placed on the spacer 81.

Further, the piece portion 922 having an L-like shape in a side view thereof is provided on the second connecting member 92 so as to extend from a side surface of a substantially central portion of the second connecting member 92 on the side opposite to the beam member 93 toward the tip end side. When the second connecting member 92 is screw-fixed to the second block bodies 5, the piece portion 922 makes contact with the magnetic member 7 arranged on the second block bodies 5. With this configuration, it is possible to screw-fix the second connecting member 92 to the second block bodies 5 in a state that the second connecting member 92 is stably placed on the tip end portions 22 of the magnetostrictive rods 2.

The beam member 93 connects the central portion of the first connecting member 91 and the central portion of the second connecting member 92. In the power generator 1, this beam member 93 and the magnetostrictive rods 2 are arranged so as not to overlap with each other in the planar view (see FIG. 1) and configured so that the gap between the beam member 93 and the magnetostrictive rods 2 decreases from the base end side to the tip end side in the side view (see FIG. 3(c)). In this embodiment, a width of the beam member 93 is set so as to be smaller than a gap between the coils 3 respectively wound around the magnetostrictive rods 2. Further, the beam member 93 is configured to overlap with the coils 3 on the tip end side in the side view.

In the power generator 1, the magnetostrictive rods 2 and the beam member 93 serve as beams facing each other. The magnetostrictive rods 2 and the beam member 93 are displaced in the same direction (the upper direction or the lower direction in FIG. 1) together when the second block bodies 5 are displaced. At this time, stress is generated in each of the magnetostrictive rods 2 due to the beam member 93. Since the beam member 93 is arranged between the coils 3 respectively wound around the magnetostrictive rods 2, each of the magnetostrictive rods 2 does not make contact with the beam member 93 when each of the magnetostrictive rods 2 is displaced.

The power generator 1 as described above is used in a state that the first block bodies 4 are fixed to the housing 100 of the vibrating body through the male screws (not shown in the drawings) screwed with the female screw portions 816 of the first bracket portions 812 of the spacer 81 (see FIGS. 3(a) and 3(b)). In this state, when the second block bodies 5 are displaced (pivotally moved) with respect to the first block bodies 4 in the lower direction by the vibration of the vibrating body (see FIG. 6(b)), that is when the tip end portions 22 of the magnetostrictive rods 2 are displaced with respect to the base end portions 21 of the magnetostrictive rods 2 in the lower direction, the beam member 93 is deformed so as to be expanded in an axial direction thereof and the magnetostrictive rods 2 are deformed so as to be contracted in the axial direction thereof. On the other hand, when the second block bodies 5 are displaced (pivotally moved) toward the upper direction, that is when the tip end portions 22 of the magnetostrictive rods 2 are displaced with respect to the base end portions 21 of the magnetostrictive rods 2 in the upper direction, the beam member 93 is deformed so as to be contracted in the axial direction thereof and the magnetostrictive rods 2 are deformed so as to be expanded in the axial direction thereof. As a result, the magnetic permeability of each of the magnetostrictive rods 2 varies due to the inverse magnetostrictive effect. This variation of the magnetic permeability of each of the magnetostrictive rods 2 leads to the variation of the density of the lines of magnetic force passing through the magnetostrictive rods 2 (the density of the lines of magnetic force passing through the coils 3), thereby generating the voltage in the coils 3.

Further, as described above, the power generator 1 is configured so that the gap between the magnetostrictive rods 2 and the beam member 93 (hereinafter, this gap is referred to as “beam gap”) decreases from the base end side to the tip end side in the side view. In other words, the magnetostrictive rods 2 and the beam member 93 form a beam structure (tapered beam structure) tapering from the base end side to the tip end side (see FIG. 3(c)). In such a structure, stiffness of a pair of beams constituted of the magnetostrictive rods 2 and the beam member 93 in a displacement direction (the vertical direction) decreases from the base end side to the tip end side. Thus, when the external force is applied to the tip end portion of the power generator 1 (the second block bodies 5), the magnetostrictive rods 2 and the beam member 93 can be smoothly displaced in the vertical direction. As a result, it is possible to reduce variation in the stress generated in each of the magnetostrictive rods 2 in the thickness direction thereof, thereby generating uniform stress in each of the magnetostrictive rods 2 and improving the power generation efficiency of the power generator 1.

Further, according to the power generator 1, it is possible to freely design the beam gap between the magnetostrictive rods 2 and the beam member 93. Specifically, by adjusting the thickness of the plate portion 811 of the spacer 81 to be placed on the tall block portions 41 of the first block bodies 4, it is possible to freely design the beam gap between the magnetostrictive rods 2 and the beam member 93 on the base end side. Thus, it is possible to freely design the beam gap between the magnetostrictive rods 2 and the beam member 93.

A relationship between the beam gap between the pair of beams and the stress generated when the external force is applied to the tip end portions of the pair of beams has been analyzed by the inventors of the present invention. Further, from the following results of study, it has been found that substantially uniform stress is generated in each beam when the beam gap decreases.

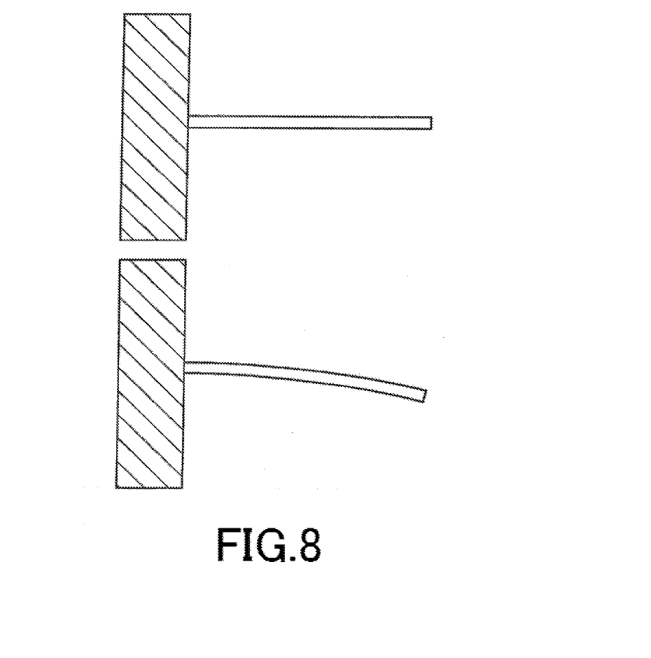

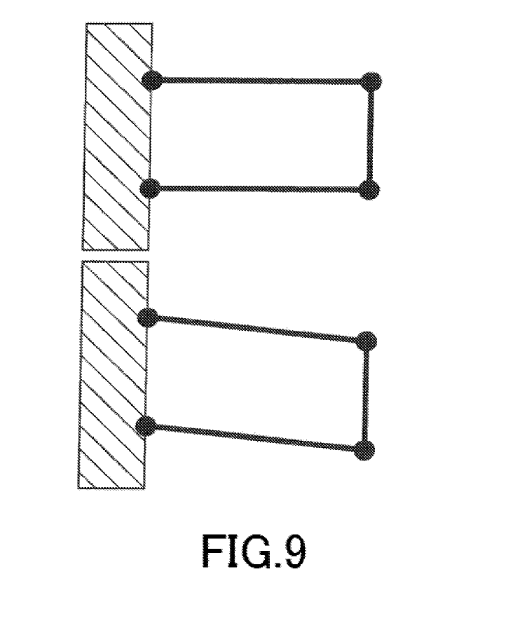

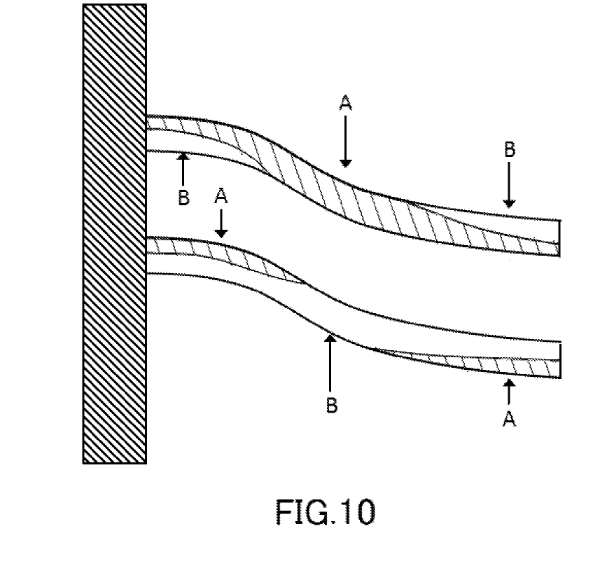

FIG. 8 is a side view schematically showing a state that external force in the lower direction is applied to a tip end portion of one rod member (one beam) whose base end portion is fixed to a housing. FIG. 9 is a side view schematically showing a state that external force in the lower direction is applied to the tip end portions of the pair of beams (parallel beams) parallel arranged so as to face each other whose base end portions are fixed to the housing. FIG. 10 is a view schematically showing the stress (the tensile stress and the compressive stress) generated in the pair of parallel beams when the external force is applied to tip end portions of the pair of parallel beams.

Hereinafter, an upper side in each of FIGS. 8 to 10 is referred to as “upper” or “upper side” and a lower side in each of FIGS. 8 to 10 is referred to as “lower” or “lower side”. Further, a left side in each of FIGS. 8 to 10 is referred to as “base end side” and a right side in each of FIGS. 8 to 10 is referred to as “tip end side”.

When the external force is applied to the tip end portion of one beam so that the beam is bent and deformed in the lower direction as shown in FIG. 8, the stress is generated in the beam due to this bending deformation of the beam. At this time, uniform tensile stress (stretching stress) is generated on an upper portion of the beam and uniform compressive stress (contraction stress) is generated on a lower portion of the beam. On the other hand, when the external force is applied to the tip end portions of the parallel beams having a certain beam gap, the pair of beams are deformed with two states simultaneously occurring. One of the two states is that each beam is bent and deformed as shown in FIG. 8. The other one of the two states is that the pair of beams are deformed as shown in FIG. 9 so as to perform a parallel link movement for keeping the beam gap on the tip end side constant before and after the external force is applied. In the parallel beams, this parallel link operation becomes marked as the beam gap increases. On the other hand, the parallel link operation is suppressed as the beam gap decreases. Thus, the deformations of the parallel beams become similar to the bending deformation of the one beam as shown in FIG. 8 as the beam gap decreases.

Thus, the bending deformation as shown in FIG. 8 and the deformations due to the parallel link movement as shown in FIG. 9 simultaneously occur in the configuration of the parallel beams having a relatively large beam gap. As a result, each beam is deformed in a substantially S-like shape as shown in FIG. 10. When the parallel beams are deformed in the lower direction, it is preferable that uniform tensile stress is generated in the upper beam. Actually, as shown in FIG. 10, although tensile stress A is generated in a central portion of the upper beam, large compressive stress B is generated in a lower portion of the upper beam on the base end side and an upper portion of the upper beam on the tip end side. Further, it is preferable that uniform compressive stress is generated in the lower beam. Actually, although the compressive stress B is generated in a central portion of the lower beam, the large tensile stress A is generated in an upper portion of the lower beam on the base end side and a lower portion of the lower beam on the tip end side. Namely, since both of the tensile stress A and the compressive stress B generated in each beam are large, it is impossible to increase an absolute value of one of the tensile stress and the compressive stress generated in an entire of the beam. Thus, in the case of using the described parallel beams as the magnetostrictive rods, it is impossible to increase the variation amount of the magnetic flux density in each of the magnetostrictive rods.

In this regard, there is the following relationship between the variation amount of the magnetic flux density and magnitude of the stress (the tensile stress or the compressive stress) generated in the magnetostrictive rod to which the bias magnetic field is applied.

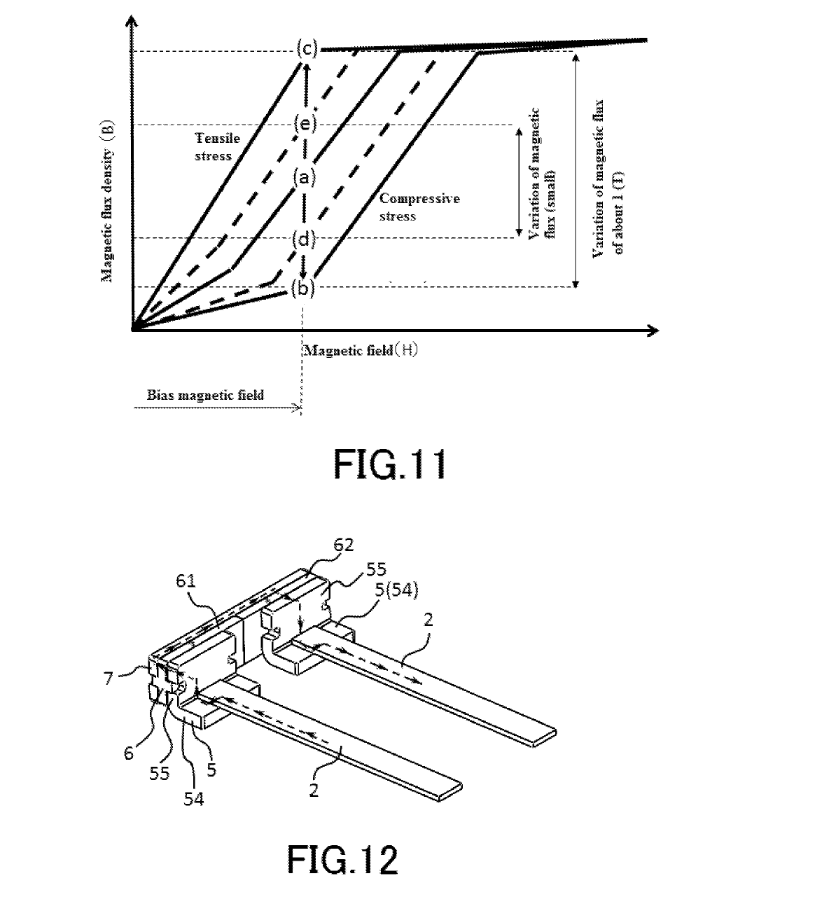

FIG. 11 is a graph showing the relationship between the magnetic flux density (B) and the bias magnetic field (H) applied to the magnetostrictive rod formed of the magnetostrictive material containing the iron-gallium based alloy (having the Young's modulus of about 70 GPa) as the main component thereof depending on the stress generated in the magnetostrictive rod.

In FIG. 11, “(a)” represents a state that stress is not generated in the magnetostrictive rod, “(b)” represents a state that compressive stress of 90 MPa is generated in the magnetostrictive rod, “(c)” represents a state that tensile stress of 90 MPa is generated in the magnetostrictive rod, “(d)” represents a state that compressive stress of 50 MPa is generated in the magnetostrictive rod and (e) represents a state that tensile stress of 50 MPa is generated in the magnetostrictive rod.

Magnetic permeability of the magnetostrictive rod in which the tensile stress is generated is higher than magnetic permeability of the magnetostrictive rod in which the stress is not generated. As a result, the density of the lines of magnetic force passing through the magnetostrictive rod in which the tensile stress is generated in the axial direction thereof becomes higher as shown in FIG. 11 (the cases of “(c)” and “(e)”). On the other hand, magnetic permeability of the magnetostrictive rod in which the compressive stress is generated is lower than the magnetic permeability of the magnetostrictive rod in which the stress is not generated. As a result, the density of the lines of magnetic force passing through the magnetostrictive rod in which the compressive stress is generated in the axial direction thereof becomes lower (the cases of “(b)” and “(d)”).

Thus, when the other end portion of the magnetostrictive rod is vibrated (displaced) with respect to the one end portion thereof in a state that a certain bias magnetic field shown in FIG. 11 is applied to the magnetostrictive rod to alternately generate the tensile stress of 90 MPa and the compressive stress of 90 MPa in the magnetostrictive, the variation amount of the magnetic flux density passing through the magnetostrictive rod becomes a maximum of about 1T (see the cases of “(b)” and “(c)”). On the other hand, when the tensile stress and the compressive stress generated in the magnetostrictive rod are decreased to MPa, the variation amount of the magnetic flux density passing through the magnetostrictive rod also decreases (see the cases of “(d)” and “(e)”).

Thus, in order to increase the variation amount of the magnetic flux density passing through the magnetostrictive rod, it is necessary to sufficiently increase the tensile stress or the compressive stress (the stress in a constant direction) generated in the magnetostrictive rod. In this regard, in the case of using the magnetostrictive rod formed of the above-mentioned magnetostrictive material, by alternately generating tensile stress of 70 MPa and compressive stress of 70 MPa in the magnetostrictive rod, it is possible to sufficiently increase the variation amount of the magnetic flux density passing through the magnetostrictive rod.

From the above results of study, the following fact has been found. Namely, from a point of view of improving the power generation efficiency, it is preferable that the power generator whose magnetostrictive rods and beam member constitute the pair of parallel beams are configured so that a behavior of a bending deformation of the pair of parallel beams becomes similar to a behavior of the bending deformation of one beam as shown in FIG. 8 by decreasing the beam gap between the magnetostrictive rods and the beam member to suppress the parallel link movement of the beams.

In this regard, the inventors of the present invention have found that although it is possible to improve uniformity of the stress generated in each of the magnetostrictive rods by decreasing the beam gap between the magnetostrictive rods and the beam member, variation in the stress in the thickness direction of the magnetostrictive rod remains in the both end portions of each of the magnetostrictive rods. As a result of more study, the inventors of the present invention have found that it is also possible to reduce the variation in the stress in the thickness direction of the magnetostrictive rod remaining in the both end portions of each of the magnetostrictive rods by setting the beam gap between the magnetostrictive rods 2 and the beam member 93 on the tip end side to be smaller than the beam gap between the magnetostrictive rods 2 and the beam member 93 on the base end side.

For the reasons stated above, from the point of view of improving the power generation efficiency of the power generator 1, it is preferable that the magnetostrictive rods 2 and the beam member 93 form the tapered beam structure and the beam gap between the magnetostrictive rods 2 and the beam member 93 is decreased to allow the behavior of the bending deformation of each of the magnetostrictive rods 2 to be similar to the behavior of the bending deformation of one beam as shown in FIG. 8. In the power generator 1, since the size of each of the coils 3 is not limited by the beam gap between the magnetostrictive rods 2 and the beam member 93, it is possible to sufficiently increase the size of each of the coils 3 and design the power generator 1 so that the beam gap between the magnetostrictive rods 2 and the beam member 93 becomes sufficiently small. With this configuration, it is possible to increase the size of each of the coils 3 and more uniform the stress generated in each of the magnetostrictive rods 2, thereby improving the power generation efficiency of the power generator 1.

Further, in the power generator 1, the stiffness of the pair of beams constituted of the magnetostrictive rods 2 and the beam member 93 in the displacement direction decreases from the base end side to the tip end side. Thus, it is possible to drastically deform the magnetostrictive rods 2 in the vertical direction with relatively small external force.

In this regard, an angle formed by the beam member 93 and each of the magnetostrictive rods 2 (taper angle) in the side view is not particularly limited to a specific value, but is preferably in the range of about 0.5 to 10°, and more preferably in the range of about 1 to 7°. If the angle formed by the beam member 93 and each of the magnetostrictive rods 2 is in the above range, it is possible to form the above tapered beam structure with the magnetostrictive rods 2 and the beam member 93 and sufficiently decrease the beam gap between the magnetostrictive rods 2 and the beam member 93 on the base end side. With this configuration, it is possible to generate more uniform stress in each of the magnetostrictive rods 2.

Although a spring constant of the beam member 93 as described above may be different from a spring constant of each of the magnetostrictive rods 2, it is preferable that the spring constant of the beam member 93 is equal to a total value of the spring constants of all of the magnetostrictive rods 2, that is a total value of the spring constants of the two magnetostrictive rods 2. As described above, in this embodiment, the two magnetostrictive rods 2 and the one beam member 93 serve as the pair of beams facing each other. Thus, by using the beam member 93 (connecting portion 9) satisfying the above condition, it is possible to uniform the stiffness in the vertical direction between the beam member 93 and the magnetostrictive rods 2. With this configuration, it is possible to smoothly and reliably displace the second block bodies 5 with respect the first block bodies 4 in the vertical direction.

Further, generally, when external force F is applied to a movable end portion (other end portion) of a cantilevered beam whose one end portion is fixed, a deformation (bending amount) d of the beam can be expressed by the following formula (2).

d=FL³/3EI (2)
(wherein “L” is a length of the beam, “E” is a Young's modulus of a constituent material for the beam and “I” is a cross-sectional secondary moment of the beam)

In the power generator 1, cross-sectional areas and cross-sectional shapes of each magnetostrictive rod 2 and the beam member 93 are substantially equal to each other. Thus, cross-sectional secondary moments of each magnetostrictive rod 2 and the beam member 93 are also substantially equal to each other. Further, lengths of each magnetostrictive rod 2 and the beam member 93 are substantially equal to each other. Thus, according to the above formula (2), in the case where the power generator 1 takes a configuration in which the number of the beam members 93 is one and the number of the magnetostrictive rods 2 is two, it is preferable that a Young's modulus of the beam member 93 is set to be about twice of a Young's modulus of each magnetostrictive rod 2. With this configuration, each beam (each of the beam member 93 and the two magnetostrictive rods 2) is similarly deformed (bent) by the external force. In other words, it is possible to achieve a good balance among the stiffness of each beam in the vertical direction.

Further, the Young's modulus of the beam member 93 as described above is preferably in the range of about 80 to 200 GPa, more preferably in the range of about 100 to 190 GPa, and even more preferably in the range of about 120 to 180 GPa.

Since each of the spacers 81, 82 and the connecting portion 9 is formed of the weakly magnetic material or the non-magnetic material as described above, it is possible to prevent the magnetic field loop constituted of the magnetostrictive elements 10 (the magnetostrictive rods 2 and each block body 4, 5), the permanent magnets 6 and the magnetic members 7 from short-circuiting by the spacers 81, 82 and the connecting portion 9. From a point of view of more reliably preventing the short-circuit of the magnetic field loop, it is preferable that each of the spacers 81, 82 and the connecting portion 9 is formed of the non-magnetic material.

The non-magnetic material for the spacers 81, 82 and the connecting portion 9 is not particularly limited to a specific kind. Examples of the non-magnetic material include a metallic material, a semiconductor material, a ceramic material, a resin material and a combination of two or more of these materials. In the case of using the resin material as the non-magnetic material, it is preferred that filler is added into the resin material. Among them, a non-magnetic material containing a metallic material as a main component thereof is preferably used. Further, a non-magnetic material containing at least one selected from the group consisting of stainless steel, beryllium copper, aluminum, magnesium, zinc, copper and an alloy containing at least one of these materials as a main component thereof is more preferably used.

In the case of using the magnetostrictive material containing the iron-gallium based alloy (having the Young's modulus of about 70 GPa) as the main component thereof as the constituent material for the magnetostrictive rods 2, it is preferable to use the stainless steel (“SUS 316”, having a Young's modulus of about 170 GPa) as the constituent material for the connecting portion 9. By using these materials respectively having these above Young's modulus as the constituent materials for the magnetostrictive rods 2 and the beam member 93, it is possible to achieve a good balance among the stiffness of the beam member 93 and the two magnetostrictive rods 2 in the vertical direction. With this configuration, it is possible to smoothly and reliably displace the second block bodies 5 with respect to the first block bodies 4 in the vertical direction.

A thickness (cross-sectional area) of the beam member 93 as described above is substantially constant. An average thickness of the beam member 93 is not particularly limited to a specific value, but is preferably in the range of about 0.3 to 10 mm, and more preferably in the range of about 0.5 to 5 mm. Further, an average cross-sectional area of the beam member 93 is preferably in the range of about 0.2 to 200 mm², and more preferably in the range of about 0.5 to 50 mm².

The vibrating body to which the power generator 1 is attached is, for example, a duct or a pipe used for forming a flow channel in a device for delivering (discharging, ventilating, inspiring, wasting or circulating) steam, water, fuel oil and gas (such as air and fuel gas). Examples of the pipe and the duct include a pipe and an air-conditioning duct installed in a big facility, building, station and the like. Further, the vibrating body to which the power generator 1 is attached is not limited to such a pipe and an air-conditioning duct. Examples of the vibrating body include a transportation (such as a freight train, an automobile and a back of truck), a crosstie (skid) for railroad, a wall panel of an express highway or a tunnel, a bridge, a vibrating device such as a pump and a turbine.

The vibration of the vibrating body is unwanted vibration for delivering an objective medium (in the case of the air-conditioning duct, gas and the like passing through the duct). The vibration of the vibrating body normally results in noise and uncomfortable vibration. In the present invention, by fixedly attaching the power generator 1 to such a vibrating body, it is possible to generate electric energy in the power generator 1 by converting (regenerating) such unwanted vibration (kinetic energy).

The power generator 1 can be utilized for a power supply of a sensor, a wireless communication device and the like. For example, the power generator 1 can be utilized in a system containing a sensor and a wireless communication device. In this system, by utilizing the electric energy (electric power) generated by the power generator 1 to drive the sensor, the sensor can get measured data such as illumination intensity, temperature, humidity, pressure and noise in a facility or a residential space. Further, by utilizing the electric power generated by the power generator 1 to drive the wireless communication device, the wireless communication device can transmit the data measured by the sensor to an external device (such as a server and a host computer) as detected data. The external device can use the measured data as various control signals or a monitoring signal. Furthermore, the power generator 1 can be used for a system for monitoring status of each component of vehicle (for example, a tire pressure sensor and a sensor for seat belt wearing detection). Further, by converting such unwanted vibration of the vibrating body to the electric energy with the power generator 1, it is possible to provide an effect of reducing the noise and the uncomfortable vibration generated from the vibrating body.

Further, in addition to the intended use of regenerating the vibration from the vibrating body as described above, by providing the power generator 1 with a mechanism for fixing the first block bodies 4 to a base body other than the vibrating body and directly applying the external force to the tip end portion of the power generator 1 (the second block bodies 5) from the outside and combining the power generator 1 with a wireless communication device, it is possible to obtain a switching device which can be manually operated by a user. For example, in the case of using the power generator 1 of this embodiment in the switching device, the user presses the piece portion 922 provided on the second connecting member 92 toward the lower side with a finger and then lifts up the finger toward the tip end side to release the pressure to the piece portion 922. With this operation, the tip end portions of the magnetostrictive elements 10 are displaced (vibrated) in the vertical direction, thereby generating the voltage in the coils 3.

Such a switching device can function without being wired for a power supply (external power supply) and a signal line. For example, the switching device can be used for a wireless switch for house lighting, a home security system (in particular, a system for wirelessly informing detection of operation of a window or a door) or the like.

Further, by applying the power generator 1 to each switch of a vehicle, it becomes unnecessary to wire the switch for the power supply and the signal line. With such a configuration, it is possible to reduce the number of assembling steps and a weight of a wire provided in the vehicle, thereby achieving weight saving of the vehicle or the like. This makes it possible to suppress a load on a tire, a vehicle body and an engine and contribute to safety of the vehicle.

The power generation amount of the power generator is not particularly limited to a specific value, but is preferably in the range of about 20 to 2000 μJ. If the power generation amount of the power generator 1 (power generating capability of the power generator 1) is in the above range, it is possible to efficiently utilize the electric power generated by the power generator 1 for the wireless switch for house lighting, the home security system or the like described above in combination with a wireless communication device.

In this regard, it may be possible to take a configuration in which an initial load (bias stress) is generated in each of the magnetostrictive rods 2 by the beam member 93.

For example, by shortening the length of the beam member 93, it is possible to generate tensile stress in each of the magnetostrictive rods 2 in a natural state. In this case, when the external force is applied to the second block bodies 5 in the upper direction, the magnetostrictive rods 2 are more drastically displaced toward the upper direction compared with the case where the bias stress is not generated in each of the magnetostrictive rods 2. With this configuration, it is possible to more increase the tensile stress generated in each of the magnetostrictive rods 2, thereby more improving the power generation efficiency of the power generator 1.

Further, by elongating the length of the beam member 93, it is possible to generate compressive stress in each of the magnetostrictive rods 2 in the natural state. In this case, when the external force is applied to the second block bodies 5 in the lower direction, the magnetostrictive rods 2 are more drastically displaced toward the lower direction compared with the case where the bias stress is not generated in each of the magnetostrictive rods 2. With this configuration, it is possible to more increase the compressive stress generated in each of the magnetostrictive rods 2, thereby more improving the power generation efficiency of the power generator 1.

Although the coils 3 respectively wound around the magnetostrictive rods 2 and the beam member 93 are arranged so as not to overlap with each other in the planar view in the power generator 1 according to this embodiment, it may be possible to take a configuration in which parts of the coils 3 overlap with the beam member 93 in the planar view. Specifically, it may be possible to take a configuration in which the magnetostrictive rods 2 and the beam member 93 do not overlap with each other in the planar view and end portions of the coils 3 and the end portions of the beam member 93 overlap with each other in the planar view. Even in the case of taking such a configuration, it is possible to sufficiently ensure the winding spaces for the coils 3 and sufficiently decrease the beam gap between the magnetostrictive rods 2 and the beam member 93 within a range that the coils 3 and the beam member 93 do not make contact with each other, thereby providing the same effect as the effect provided by the above power generator 1.

Further, in the power generator 1 of this embodiment, although the gap between the beam member 93 and the magnetostrictive rods 2 decreases from the base end side to the tip end side in the side view, the present invention is not limited thereto. For example, in the case of taking a configuration in which the spacer 81 is not used and the first connecting member 91 directly connects the first block bodies (the tall block portions 41) with each other, the gap between the beam member 93 and the magnetostrictive rods 2 becomes substantially constant from the base end side to the tip end side. Even in the case of taking such a configuration, it is possible to provide the same effect and function as the effect and function provided by the above power generator 1.

Further, the power generator 1 of this embodiment includes the two magnetostrictive rods 2 and the one beam member 93 as the beams facing each other. However, the power generator 1 of the present invention is not limited thereto and it is possible to take the following configuration.

For example, it may be possible to take a configuration in which the connecting portion includes two beam members for respectively connecting the end portions of the first connecting member in the longitudinal direction thereof and the end portions of the second connecting member in the longitudinal direction thereof. In this configuration, since the beam members are arranged on the outer side of the magnetostrictive rods, it is possible to increase the size of each of the coils and decrease the gap between the magnetostrictive rods, thereby reducing a size of the power generator 1 in the width direction thereof. Even in the case of taking this configuration, it is possible to provide the same effect and function as the effect and function provided by the power generator 1 of the described embodiment.

Further, in the power generator 1 of this embodiment, the permanent magnets 6 are arranged so that the magnetization directions (the first magnetization direction and the second magnetization direction) of the permanent magnets 6 are parallel to the displacement direction in which the other end portions of the magnetostrictive elements 10 can be displaced. However, the power generator 1 of this embodiment is not limited thereto and it is possible to take the following configuration.

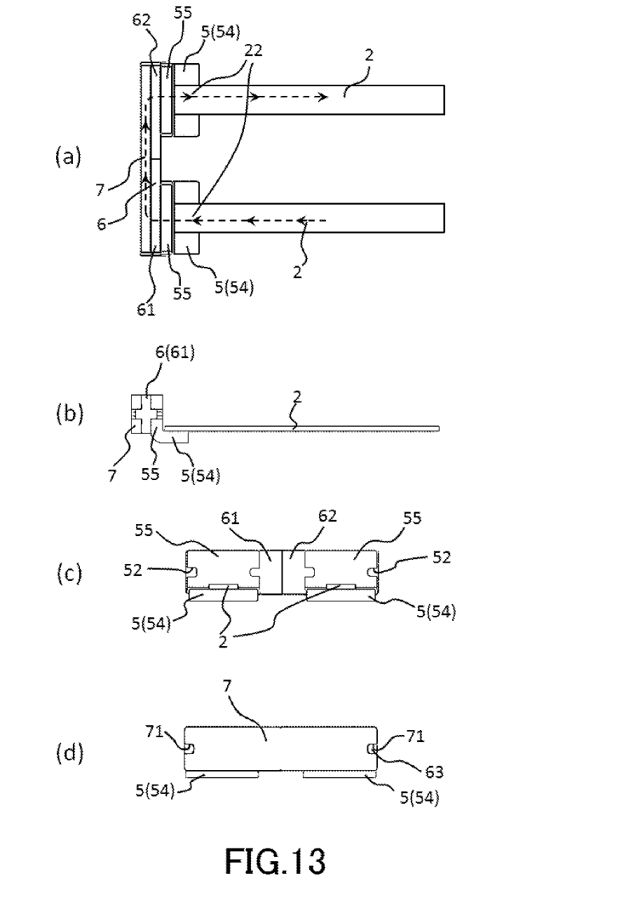

FIG. 12 is a perspective view showing a configuration on the tip end side of another configuration example of the power generator of the first embodiment of the present invention (with the coils, the spacer, the connecting portion and the female screw portions of the second block bodies being omitted). FIG. 13(a) is a planar view of the power generator shown in FIG. 12. FIG. 13(b) is a side view of the power generator shown in FIG. 12. FIG. 13(c) is a front view of the power generator shown in FIG. 12. FIG. 13(d) is a back view of the power generator shown in FIG. 12.

Hereinafter, an upper side in each of FIGS. 12, 13(b), 13(c) and 13(d) and a front side of the paper in FIG. 13(a) are referred to as “upper” or “upper side” and a lower side in each of FIGS. 12, 13(b), 13(c) and 13(d) and a rear side of the paper in FIG. 13(a) are referred to as “lower” or “lower side”. Further, a left and rear side of the paper in FIG. 12 and a left side of each of FIGS. 13(a) and 13(b) are referred to as “tip end side” and a right and front side of the paper in FIG. 12 and a right side in each of FIGS. 13(a) and 13(b) are referred to as “base end side”.

In the power generator 1 shown in FIGS. 12 and 13, each of the second block bodies 5 includes a bottom plate portion 54 which extends toward the base end side and on which the tip end portion 22 of the magnetostrictive rod 2 is placed and a standing plate portion 55 extending from a tip end portion of the bottom plate portion 54 toward the upper direction. The second block body 5 having such a configuration can be obtained by preparing the same block body as the second block body 5 used in the power generator 1 shown in FIGS. 1 and 2 and bending the block body with a press work, a bending work, a hammering work or the like so that the bottom plate portion 54 and the standing plate portion 55 form a L-like shape in the side view.

Cutout portions 52 same as the cutout portions 52 of the second block bodies 5 used in the power generator 1 shown in FIG. 2 are formed in the standing plate portions 55 of the second block bodies 5. The protruding portions 63 of the permanent magnet 6 engage with the cutout portions 52. The permanent magnets 6 and the magnetic member 7 are attached to a tip end side surface of the standing plate portions 55 of the second block bodies 5 (see FIG. 12).

A height of each of the standing plate portions 55 (a length in the vertical direction in FIG. 13(b)) is substantially equal to a length of the permanent magnet 6 in a short direction of the permanent magnet 6. Thus, according to the power generator 1 having such a configuration, it is also possible to sufficiently increase a square measure of a contacting surface between the permanent magnet 6 and the standing plate portion 55 (the second block body 5) as is the case for the power generator 1 shown in FIGS. 1 and 2 (see FIGS. 12, 13(b) and 13(c)).

The power generator 1 having such a configuration has the same configuration as the power generator 1 of the described embodiment except that the shape of each of the second block bodies 5 and an attachment direction of the permanent magnet 6 and the magnetic member 7 with respect to the second block bodies 5 are modified.

As shown in FIG. 13(a), the first portion 61 of the permanent magnet 6 is attached to the tip end surface of the standing plate portion 55 of the second block body 5 arranged on the lower side in FIG. 13(a). On the other hand, the second portion 62 of the permanent magnet 6 is attached to the tip end surface of the standing plate portion 55 of the second block body 5 arranged on the upper side in FIG. 13(a). The first portion 61 is formed (magnetized) so that its north pole is directed toward the tip end side and its south pole is directed toward the base end side. The second portion 62 is formed (magnetized) so that its south pole is directed toward the tip end side and its north pole is directed toward the base end side. Namely, in the power generator 1 shown in FIGS. 12 and 13, each of a magnetization direction (a first magnetization direction) of the first portion 61 of the permanent magnet 6 and a magnetization direction (a second magnetization direction) of the second portion 62 is parallel to the axial direction of the magnetostrictive rods 2.

Here, a flow of the lines of magnetic force on the tip end side of the power generator 1 is illustrated in FIGS. 12 and 13.

Namely, as is the case for the power generator 1 shown in FIG. 1, lines of magnetic force passing through the magnetostrictive rod 2 arranged on the front side of the paper in FIG. 12 from the base end side to the tip end side pass through the bottom plate portion 54 and the standing plate portion 55 of the second block body 5 in this order and then flow into the first portion 61. Further, lines of magnetic force generated from the first portion 61 pass through the magnetic member 7 arranged on the tip end side of the power generator 1 in the longitudinal direction of the magnetic member 7 and then flow into the second portion 62. Furthermore, lines of magnetic force generated from the second portion 62 pass through the standing plate portion 55 and the bottom plate portion 54 of the second block body 5 in this order and then flow in the magnetostrictive rod 2 arranged on the rear side of the paper in FIG. 12 from the tip end side to the base end side.

According to the power generator 1 having such a configuration, it is also possible to sufficiently increase a square measure of a contacting surface between the permanent magnet 6 (the first portion 61 and the second portion 62) and each block body 4, 5, thereby providing the same effect and function as the effect and function provided by the power generator 1 of the described embodiment.

Further, it is possible to modify the shape of each of the first block bodies 4 in the same manner as the second block bodies 5 shown in FIG. 12 and attach the permanent magnet 6 to a base end surface of each of the first block bodies 4 so that each of magnetization directions of the first portion 61 and the second portion 62 of the permanent magnet 6 is parallel to the axial direction of the magnetostrictive rods 2.

Although the description is given to the configuration of the power generator 1 of this embodiment using the one dipole magnet including the first portion 61 having the first magnetization direction and the second portion 62 having the second magnetization direction opposed to the first magnetization direction as the permanent magnet 6, the present invention is not limited thereto. For example, it is possible to use two monopole magnets whose magnetization directions are opposed to each other instead of the one dipole magnet.

Further, the power generator 1 can take a configuration including two or more of the magnetostrictive rods 2 and one or more of the beam members 93. In the case of changing a total number of the magnetostrictive rods 2 and the beam members 93, it is preferable that this total number is an odd number. Specifically, the power generator 1 can take a configuration in which a ratio of the number of the magnetostrictive rods 2 and the number of the beam members 93 (the number of the magnetostrictive rods 2:the number of the beam members 93) becomes 2:3, 3:2, 3:4, 4:3, 4:5 or the like. In such a configuration, since the magnetostrictive rods 2 and the beam members 93 serving as the beams are symmetrically arranged in the width direction of the power generator 1, it is possible to achieve a good balance among the stress generated in the magnetostrictive rods 2, each block body 4, 5 and the connecting portion 9.

In the case of taking the configuration as described above, when the spring constant of each of the beam members 93 is defined as “A” [N/m], the number of the beam members 93 is defined as “X”, the spring constant of each of the magnetostrictive rods 2 is defined as “B” [N/m] and the number of the magnetostrictive rods 2 is defined as “Y”, it is preferable that the power generator 1 is configured so that a value of “A×X” is substantially equal to a value of “B×Y”. With this configuration, it is possible to smoothly and reliably displace the second block bodies 5 with respect to the first block bodies 4 in the vertical direction.

In the case where the number of the magnetostrictive rods 2 is three or more, it is preferable that a multipole magnet having the same number of poles as the number of the magnetostrictive rods 2 is used as the permanent magnet 6. The multipole magnet has a configuration in which the first portion 61 and the second portion 62 described above are alternately arranged in a longitudinal direction of the multipole magnet. For example, in the case where the number of the magnetostrictive rods 2 is three, it is possible to use a triple pole magnet in which the first portion 61, the second portion 62 and the first portion 61 are arranged in this order in a longitudinal direction of the triple pole magnet. In the case where the number of the magnetostrictive rods 2 is four, it is possible to use a quadrupole magnet in which the first portion 61, the second portion 62, the first portion 61 and the second portion 62 are arranged in this order in a longitudinal direction of the triple pole magnet.

In the above description, the fixing of the both end portions 21, 22 of the magnetostrictive rods 2 to each block body 4, 5 and the connection of the connecting portion 9 to each block body 4, 5 are achieved by respectively screwing the male screws 43, 53 with the female screw portions 411, 51, but the fixing and connecting method for each component is not limited to this screwing method. Examples of the fixing and connecting method for each component include a welding method (such as a laser welding method and an electric welding method), a pin pressure fitting method and a bonding method with an adhesive agent.

In particular, the fixing of the both end portions 21, 22 of the magnetostrictive rods 2 to each block body 4, 5 is preferably achieved by the welding method, and more preferably achieved by the laser welding method. Further, the fixing of each connecting member 91, 92 arranged on the both end portions 21, 22 of the magnetostrictive rods 2 to the spacers 81, 82 and the fixing of the magnetostrictive rods 2 to the each block body 4, 5 are preferably achieved by the laser welding method.

More specifically, the base end portions 21 of the magnetostrictive rods 2 are placed on the first block bodies 4 and then the spacer 81 and the first connecting member 91 are placed on the base end portions 21 of the magnetostrictive rods 2. By irradiating these members with laser from the lower side of the first block bodies 4 and the upper side of the first connecting member 91 in this state, these members are welded. Further, the tip end portions 22 of the magnetostrictive rods 2 are placed on the second block bodies 5 and then the second connecting member 92 and the spacer 82 are placed on the tip end portions 22 of the magnetostrictive rods 2. By irradiating these members with laser from the lower side of the second block bodies 5 and the upper side of the spacer 82 in this state, these members are welded. In the case of using this method, it becomes unnecessary to use the male screws for fixing the members with each other and to form the female screw portions and the through-holes in the members. Thus, it is possible to reduce the number of parts and the number of steps for forming the through-holes, the female screw portions and the like. As a result, it is possible to suppress the manufacturing cost of the power generator 1.

### Second Embodiment

Next, description will be given to a second embodiment of the power generator of the present invention.

FIG. 14 is a perspective view showing a flow of the lines of magnetic force on the tip end side of the second embodiment of the power generator of the present invention (with the coils, the spacer, the connecting portion and the female screw portions of the second block bodies being omitted).

Hereinafter, an upper side in FIG. 14 is referred to as “upper” or “upper side” and a lower side in FIG. 14 is referred to as “lower” or “lower side”. Further, a left and rear side of the paper in FIG. 14 is referred to as “tip end side” and a right and front side of the paper in FIG. 14 is referred to as “base end side”.

Hereinafter, the power generator according to the second embodiment will be described by placing emphasis on the points differing from the power generator according to the first embodiment, with the same matters being omitted from the description.

The power generator 1 of the second embodiment has the same configuration as the power generator 1 according to the first embodiment except that the configurations of the first block body 4 and the second block body 5 are modified.

Hereinafter, description will be given to the configurations of the first block body 4 and the second block body 5.

The power generator 1 of this embodiment is configured so that the base end portions 21 of the two magnetostrictive rods are attached to one first block body 4 and the tip end portions 22 of the two magnetostrictive rods 2 are attached to one second block body 5.

Although this matter is not illustrated in the drawings, the first block body 4 is constituted of one plate material and has the same configuration as each of the first block bodies 4 included in the power generator 1 of the first embodiment shown in FIG. 2 except that the length of the first block body 4 in the width direction thereof is modified. Specifically, the width of each of the tall block portion 41 and the short block portion 42 described above is modified so as to be substantially equal to the length of the permanent magnet 6 in the longitudinal direction thereof. Further, female screw portions 411 are formed in the tall block portion at positions respectively corresponding to the through-holes 815 of the spacer 81 (the through-holes 911 of the first connecting member 91) so as to pass through the tall block portion 41 in the thickness direction thereof. Furthermore, two cutout portions 421 are formed in both end portions of the short block portion 42 in the width direction thereof. The two protruding portions 63 engage with the two cutout portions 421.

The second block body 5 is constituted of one plate material and has the same configuration as each of the second block bodies 5 included in the power generator 1 of the first embodiment shown in FIG. 2 except that the length of the second block body 5 in the width direction thereof is modified. Specifically, the width of the second block body 5 is modified so as to be substantially equal to the length of the permanent magnet 6 in the longitudinal direction thereof. Further, female screw portions 51 are formed in the base end portion of the second block body 5 at positions respectively corresponding to the through-holes 921 of the second connecting member 92 (the through-holes 821 of the spacer 82) so as to pass through the second block body 5 in the thickness direction thereof. Furthermore, two cutout portions 52 are formed in both side portions of the tip end portion of the second block body 5 in the width direction thereof. The two protruding portions 63 engage with the two cutout portions 52.

Further, one slit is formed in the tall block portion 41 and the short block portion 42 of the first block body 4 so as to be positioned between the base end portions 21 of the magnetostrictive rods 2 placed on the first block body 4 and pass through the tall block portion 41 and the short block portion 42 of the first block body 4 in the thickness direction thereof. Furthermore, a slit is formed in the second block body 5 so as to be positioned between the tip end portions 22 of the magnetostrictive rods 2 placed on the second block body 5 and pass through the second block body 5 in the thickness direction thereof.

In this regard, the slit formed in each block body 4, 5 so as to be positioned between the end portions (between the base end portions 21 or the tip end portions 22) of the magnetostrictive rods 2 placed on the each block body 4, 5 is preferably formed so as to be positioned at a substantially intermediate position between the end portions (between the base end portions 21 or the tip end portions 22) of the magnetostrictive rods 2.

A constituent material for each block body 4, 5 may be the same material as that of the first block bodies 4 and the second block bodies 5 included in the power generator 1 of the first embodiment.

Although this matter is not illustrated in the drawings, a spacer 81 having a configuration in which the second bracket portion 813 is not provided on the plate portion 811 is used as the spacer 81 in the power generator 1 of this embodiment. Namely, in this embodiment, the power generator 1 is configured so that other portions than the concave portions 814 of the plate portion 811 make contact with the tall block portion 41 when the spacer 81 is placed on the tall block portion 41.

A flow of the lines of magnetic force passing through the power generator 1 of this embodiment on the tip end side is illustrated in FIG. 14. A flow of the lines of magnetic force passing through the power generator 1 on the base end side is same as the flow on the tip end side.

On the tip end side of the power generator 1 of this embodiment, the lines of magnetic force passing through the magnetostrictive rod 2 arranged on the front side of the paper in FIG. 14 from the base end side to the tip end side flow into the first portion 61 through the second block body 5 as is the case for the power generator 1 of the first embodiment. Further, the lines of magnetic force generated from the first portion 61 pass through the magnetic member 7 in the longitudinal direction thereof and then flow into the second portion 62. Furthermore, the lines of magnetic force generated from the second portion 62 pass through the second block body 5 and then flow in the magnetostrictive rod 2 arranged on the rear side of the paper in FIG. 14 from the tip end side to the base end side.

Further, in this embodiment, each block body 4, 5 is constituted of the one plate material. On the tip end side, parts of the lines of magnetic force flow in an area (substantially central area) in which the slit 56 is not formed from the right and rear side to the left and front side of the paper in FIG. 14 (lines of magnetic force L flowing on the base end side of the slit 56 in FIG. 14). Namely, in the power generator 1, partial short-circuit occurs in the magnetic field loop.

As described above, in the power generator 1 of this embodiment, the substantially central area of each block body 4, 5 including the slit constitutes a magnetic field short-circuit portion, in which the parts of the lines of magnetic force flow, between the base end portions 21 and the tip end portions 22 of the magnetostrictive rods 2.

The inventors of the present invention have found that it is possible to more and wholly uniform the variation amount of the magnetic flux density in the axial direction of the magnetostrictive rods 2, which is caused when the magnetostrictive rods 2 are deformed, by partially short-circuiting the magnetic field loop formed in the power generator 1.

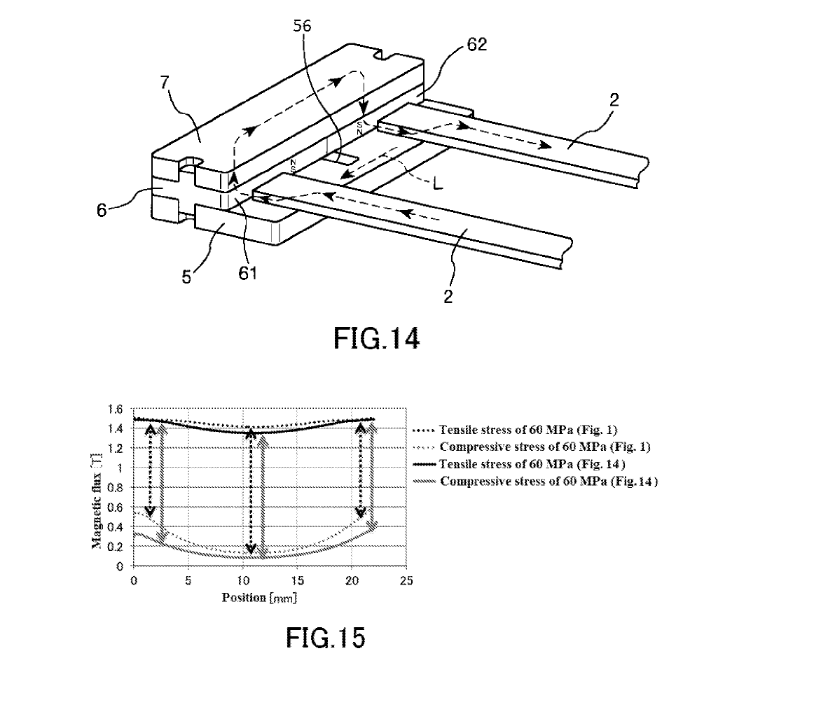

FIG. 15 is a graph showing variation of the magnetic flux density along the longitudinal direction of each of the magnetostrictive rods 2 caused when the stress is generated in the second block body 5 of the power generator shown in FIG. 1 and the power generator shown in FIG. 14. More specifically, FIG. 15 shows a relationship between the magnetic flux density passing through the magnetostrictive rod and a distance in the axial direction of the magnetostrictive rod 2 from a base end (0 mm) to a tip end of an area of the magnetostrictive rod 2 around which the coil 3 is wound when tensile stress of 60 MPa and compressive stress of 60 MPa are generated in the magnetostrictive rod 2.

In FIG. 15, the magnetostrictive rods 2 having the length (the length from the tip end of the first block body 4 to the base end of the second block body 5) of 22 mm are used in each of the power generator 1 shown in FIG. 1 and the power generator 1 shown in FIG. 14 to evaluate these power generators 1. In the power generators 1 respectively shown in FIGS. 1 and 14, a length of each block body 4, 5 from the base end to the tip end thereof is 7.5 mm. Further, the slit formed in each block body 4, 5 used in the power generator 1 shown in FIG. 14 is formed so as to be positioned at a substantially central position of each block body 4, 5 and have a width of 1.5 mm and a length of 6 mm.

As shown in FIG. 15, in the power generator 1 shown in FIG. 1 in which the end portions 21, 22 of the magnetostrictive rods 2 are respectively attached to the two first block bodies 4 and the two second block bodies 5, the variation amount of the magnetic flux density becomes maximum at a substantially central area (in the vicinity of 11 mm) of the magnetostrictive rod 2. On the other hand, the variation amount of the magnetic flux density decreases on the base end side and the tip end side of the magnetostrictive rod 2 compared with the vicinity of the central area. In contrast, in the power generator 1 shown in FIG. 14 in which the end portions 21, 22 of the magnetostrictive rods 2 are respectively attached to the one first block body 4 and the one second block body 5, the variation amount of the magnetic flux density is large not only at a substantially central area but also on the base end side and the tip end side of the magnetostrictive rod 2 (see FIG. 15).

As described above, according to the power generator 1 of this embodiment, it is possible to sufficiently increase and uniform the variation amount of the magnetic flux density caused when the magnetostrictive rods 2 are deformed in the axial direction of the magnetostrictive rods 2, thereby improving the power generation efficiency of the power generator 1.

The length of each block body 4, 5 from the base end to the tip end thereof is not particularly limited to a specific value, but is preferably in the range of about 3 to 30 mm, and more preferably in the range of about 5 to 10 mm. Further, the width (the length in the short direction) of the slit formed in each block body 4, 5 is not particularly limited to a specific value, but is preferably in the range of about 0.1 to 5 mm, and more preferably in the range of about 0.5 to 1.5 mm. Further, the length (the length in the longitudinal direction) of the slit is not particularly limited to a specific value as long as it is smaller than the length of each block body 4, 5 from the base end to the tip end thereof, but is preferably in the range of about 0.5 to 20 mm, and more preferably in the range of about 2 to 9 mm. By designing the power generator 1 so as to satisfy the above conditions, it is possible to more uniform the variation amount of the magnetic flux density caused when the magnetostrictive rods 2 are deformed in the axial direction of the magnetostrictive rods 2, thereby improving the power generation efficiency of the power generator 1.

Further, when the length of each block body 4, 5 from the base end to the tip end thereof is defined as “L_{B}” and the length of the slit is defined as “L_{S}”, a value of “L_{B}−L_{S}” is preferably in the range of about 0.5 to 5 mm, and more preferably in the range of about 1 to 3 mm. With this configuration, it is possible to sufficiently improve durability of each block body 4, 5 and more uniform the variation amount of the magnetic flux density caused when the magnetostrictive rods 2 are deformed in the axial direction of the magnetostrictive rods 2.

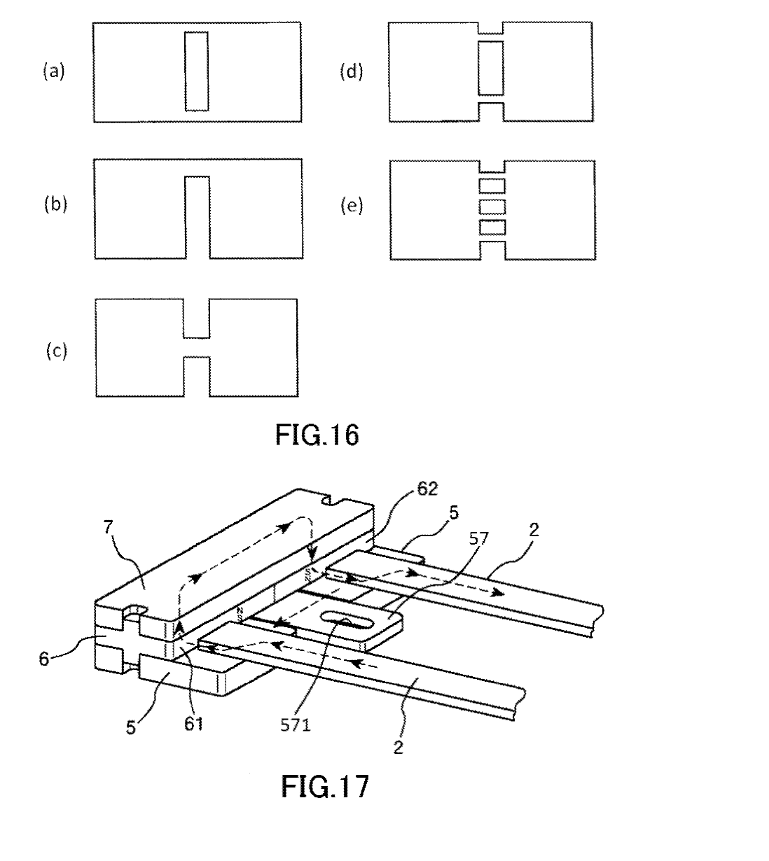

In this regard, any one of slits having patterns shown in FIG. 16 may be formed in each block body 4, 5, for example.

FIG. 16(a) is a planar view schematically showing each block body included in the power generator shown in FIG. 14. FIGS. 16(b) to 16(e) are planar views schematically showing other configuration examples of each block body included in the power generator shown in FIG. 14.

As described above, the slit is formed in the substantially central area of each block body used in the power generator 1 shown in FIG. 14 between the end portions (between the base end portions 21 and between the tip end portions 22) of the magnetostrictive rods 2 placed on the each block body. On the other hand, the slit may be formed so that the base end or the tip end of each block body 4, 5 is opened toward outside as shown in FIG. 16(b). Further, as shown in FIGS. 16(c) to 16(e), a plurality of slits may be formed in each block body 4, 5. Two slits are formed in each block body 4, 5 shown in FIG. 16(c) so that both of the base end and the tip end are opened toward outside. Each block body 4, 5 shown in FIG. 16(d) includes two slits formed so that the base end and the tip end of each block body 4, 5 are opened toward outside and one slit formed between these two slits. Each block body 4, 5 shown in FIG. 16(e) includes two slits formed so that the base end and the tip end of each block body 4, 5 are opened toward outside and three slits formed between these two slits.

Even in the case of using the block bodies 4, 5 as shown in FIGS. 16(b) to 16(e), it is possible to provide the same effect and function as the effect and function provided by the power generator 1 of this embodiment.

Further, it is preferable that the slit of each block body 4, 5 is configured so that a pin formed of a magnetic material can be inserted into the slit of each block body 4, 5. Although this matter is not illustrated in the drawings, by inserting the pin into the slit, it is possible to adjust an amount (a short-circuit amount) of the lines of magnetic force flowing from one of the base end portions 21 (or the tip end portions 22) to the other one of the base end portions 21 (or the tip end portions 22) of the two magnetostrictive rods 2. With this configuration, it becomes possible to adjust the variation amount of the magnetic flux density (the density of the lines of magnetic force) passing through the magnetostrictive rods 2. As a result, it is possible to appropriately adjust the voltage generated in the coils 3 (the power generation amount of the power generator 1) depending on the intended use of the power generator 1. A constituent material for the pin may be the same material as the constituent material for each block body 4, 5.

Examples of a configuration which can adjust the short-circuit amount of the lines of magnetic force between the end portions 21, 22 of the magnetostrictive rods 2 include the following configuration.

More specifically, in the power generator 1 of the first embodiment (see FIGS. 1 and 2), by preparing a plate material formed of a magnetic material and having a plate-like shape which can be inserted between each block body 4, 5 and changing a contacting square measure between this plate material and each block body 4, 5, it is possible to adjust the short-circuit amount of the lines of magnetic force between the end portions 21, 22 of the magnetostrictive rods 2. Hereinafter, description will be given to this configuration with reference to FIG. 17.

FIG. 17 is a perspective view showing a flow of the lines of magnetic force on the tip end side of another configuration example of the power generator of the second embodiment of the present invention (with the coils, the spacer, the connecting portion and the female screw portions of the second block bodies being omitted).

Hereinafter, an upper side in FIG. 17 is referred to as “upper” or “upper side” and a lower side in FIG. 17 is referred to as “lower” or “lower side”. Further, a left and rear side of the paper in FIG. 17 is referred to as “tip end side” and a right and front side of the paper in FIG. 17 is referred to as “base end side”.

As shown in FIG. 17, a plate material formed of a magnetic material and having a plate-like shape (a magnetic field short-circuit member 75) is arranged between the second block bodies 5. The magnetic field short-circuit member 75 is configured so that the magnetic field short-circuit member 75 can be moved in the tip end direction or the base end direction (the left and rear direction or the right and front direction of the paper in FIG. 17) between the second block bodies 5 in a state that the magnetic field short-circuit member 75 makes contact with the second block bodies 5. By moving the magnetic field short-circuit member 75 to change a contacting square measure between the magnetic field short-circuit member 75 and each of the second block bodies 5, it is possible to adjust the short-circuit amount of the lines of magnetic force between the tip end portions 22 of the magnetostrictive rods 2.

More specifically, in a state that a tip end portion of the magnetic field short-circuit member 75 is positioned closer to the base end side of the power generator 1 than the base ends of the second block bodies 5 (in a state that the magnetic field short-circuit member 75 does not make contact with the second block bodies 5), the lines of magnetic force do not flow between the tip end portions 22 of the magnetostrictive rods 2 (the short-circuit does not occur). On the other hand, in a state that the tip end portion of the magnetic field short-circuit member 75 overlaps with the base end of the permanent magnet 6 in the planar view, the short-circuit amount of the lines of magnetic force between the tip end portions 22 of the magnetostrictive rods 2 becomes maximum.

As described above, by moving the magnetic field short-circuit member 75, it is possible to adjust the short-circuit amount of the lines of magnetic force between the tip end portions 22 of the magnetostrictive rods 2 to adjust the variation amount of the magnetic flux density (the density of the lines of magnetic force) passing through the magnetostrictive rods 2.

Further, a slit 571 is formed in a substantially central area of the magnetic field short-circuit member 75 shown in FIG. 17 on the base end side. Not only by changing the contacting square measure between the magnetic field short-circuit member 75 and each of the second block bodies 5 but also changing a size of the slit 571, it is possible to adjust the short-circuit amount of the lines of magnetic force between the tip end portions 22 of the magnetostrictive rods 2. In this regard, it may be possible to take a configuration in which the slit 571 is not formed in the magnetic field short-circuit member 75.

Further, on the base end side of the power generator 1, it may be possible to arrange a plate material having the same configuration as the described magnetic field short-circuit member 75 between the first block bodies 4. Even in this case, it is possible to provide the same effect and function as the described effect and function.

The power generator 1 according to this second embodiment can also provide the same function and effect as the function and effect of the power generator 1 according to the first embodiment.

Although the power generator of the present invention has been described with reference to the preferred embodiments shown in the accompanying drawings, the present invention is not limited thereto. In the power generator, the configuration of each component may be possibly replaced with other arbitrary configurations having equivalent functions. It may be also possible to add other optional components to the present invention.

For example, it may be also possible to combine the configurations according to the first embodiment and the second embodiment of the present invention in an appropriate manner.

Further, it is possible to omit one of the two permanent magnets or replace one or both of the permanent magnets with an electromagnet. Furthermore, it is possible to take a configuration in which both of the permanent magnets are omitted and the power generator generates the electric power with utilizing an external magnetic field.

Further, although each of the magnetostrictive rods and the beam member has the rectangular cross-sectional shape in each of the first and second embodiments, the present invention is not limited thereto. Examples of the cross-sectional shape of each of the magnetostrictive rods and the beam member include a circular shape, an ellipse shape and a polygonal shape such as a triangular shape, a square shape and a hexagonal.

Further, although the permanent magnet in each of the embodiments has the columnar shape, the present invention is not limited thereto. Examples of the shape of the permanent magnet include a square columnar shape, a plate-like shape and a triangle pole shape.

### INDUSTRIAL APPLICABILITY

The power generator of the present invention includes the at least two magnetostrictive elements arranged side by side and the permanent magnet arranged so that the magnetization of the permanent magnet differs from the arrangement direction in which the magnetostrictive elements are arranged side by side. According to this power generator, it becomes unnecessary to arrange the permanent magnet between the magnetostrictive elements arranged side by side, thereby freely designing the square measure of the contacting surface between the permanent magnet and each of the magnetostrictive elements, the arrangement position of the permanent magnet and the arranged number of permanent magnets. Namely, it is possible to improve the degree of freedom for design of the permanent magnet used in the power generator. In addition, by adjusting the square measure of the contacting surface between the permanent magnet and each of the magnetostrictive elements, the arrangement position of the permanent magnet and the arranged number of permanent magnets, it is possible to suppress increasing of the size of the power generator and provide the power generator which can efficiently generate electric power. For the reasons stated above, the present invention is industrially applicable.

1. A power generator comprising:
at least two magnetostrictive elements arranged side by side, each magnetostrictive element having one end portion and the other end portion;
a connecting portion including a first connecting member for connecting the one end portions of the magnetostrictive elements, a second connecting member for connecting the other end portions of the magnetostrictive elements and at least one beam member for connecting the first connecting member and the second connecting member; and
a permanent magnet for generating lines of magnetic force passing through the magnetostrictive elements, the permanent magnet arranged so that a magnetization of the permanent magnet differs from an arrangement direction in which the magnetostrictive elements are arranged side by side,
wherein each of the magnetostrictive elements includes:
a magnetostrictive rod through which the lines of magnetic force pass in an axial direction thereof, the magnetostrictive rod formed of a magnetostrictive material and having one end portion and the other end portion; and
a coil wound around the magnetostrictive rod, and
wherein the power generator is configured to generate voltage in the coils due to variation of density of the lines of magnetic force when the other end portion of each of the magnetostrictive rods is displaced with respect to the one end portion of each of the magnetostrictive rods in a direction substantially perpendicular to the axial direction of the magnetostrictive rods to expand and contract the magnetostrictive rods.

2. The power generator as claimed in claim 1, further comprising a magnetic member formed of a magnetic material and attached to the permanent magnet,
wherein the permanent magnet is provided arranged on at least one of the sides of the one end portion and the other end portion of each of the magnetostrictive elements,
wherein the permanent magnet includes:
a first portion having a first magnetization direction perpendicular to the arrangement direction of the magnetostrictive elements; and
a second portion having a second magnetization direction opposed to the first magnetization direction, and
wherein the magnetic member and the magnetostrictive elements form a loop in which lines of magnetic force generated from the first portion flows into the second portion through the magnetic member and lines of magnetic force generated from the second portion flows into the first portion through one of the magnetostrictive rods.

3. The power generator as claimed in claim 2, wherein each of the first magnetization direction and the second magnetization direction is parallel to a displacement direction of the other end portion of each of the magnetostrictive elements.

4. The power generator as claimed in claim 2, wherein each of the first magnetization direction and the second magnetization direction is parallel to the axial direction of each of the magnetostrictive rods.

5. The power generator as claimed in claim 2, wherein each of the magnetostrictive elements further includes:
a first block body attached to the one end portion of the magnetostrictive rod, the first block body formed of a magnetic material; and
a second block body attached to the other end portion of the magnetostrictive rod, the second block body formed of a magnetic material, and
wherein the permanent magnet connects the first block bodies of the magnetostrictive elements with each other or the second block bodies of the magnetostrictive elements with each other.

6. The power generator as claimed in claim 2, wherein each of the at least two magnetostrictive elements further includes:
a first block body attached to the one end portion of the magnetostrictive rod of each of the magnetostrictive elements, the first block body formed of a magnetic material; and
a second block body attached to the other end portion of the magnetostrictive rod of each of the magnetostrictive elements, the second block body formed of a magnetic material,
wherein each of the first block body and the second block body includes a magnetic field short-circuit portion arranged between the one end portions or the other end portions of the magnetostrictive rods arranged adjacent to the first block body and the second block body and configured to flow a part of the lines of magnetic force between the one end portions or the other end portions of the magnetostrictive rods, and
wherein the permanent magnet is attached to at least one of the first block body and the second block body.

7. The power generator as claimed in claim 6, wherein the magnetic field short-circuit portion includes a slit formed at a substantially intermediate position between the one end portions or the other end portions of the magnetostrictive rods arranged adjacent to the first block body and the second block body.

8. The power generator as claimed in claim 7, wherein a width of the slit is in the range of 0.1 to 5 mm and a length of the slit is in the range of 0.5 to 20 mm.

9. The power generator as claimed in claim 7, further comprising a pin which is formed of a magnetic material and can be inserted into the slit of each of the first block body and the second block body,
wherein the power generator is configured so that a variation amount of the density of the lines of magnetic force passing through the magnetostrictive rods can be adjusted by inserting the pin into the slit.

10. The power generator as claimed in claim 1, wherein the coils respectively wound around the magnetostrictive elements and the beam member are arranged so as not to overlap with each other in a planar view.

11. The power generator as claimed in claim 1, wherein the beam member is provided between the magnetostrictive rods in a planar view.

12. The power generator as claimed in claim 1, wherein the power generator is configured so that a total number of the magnetostrictive elements and the beam member becomes an odd number.

13. The power generator as claimed in claim 1, wherein the magnetostrictive rods of the magnetostrictive elements and the beam member are arranged so as not to overlap with each other in a side view.

14. The power generator as claimed in claim 1, wherein the power generator is configured so that a gap between the beam member and each of the magnetostrictive elements on the side of the other end portion of each of the magnetostrictive elements is smaller than a gap between the beam member and each of the magnetostrictive elements on the side of the one end portion of each of the magnetostrictive elements in a side view.

15. The power generator as claimed in claim 1, wherein each of the coils includes a bobbin arranged around the magnetostrictive rod so as to surround the magnetostrictive rod and a wire wound around the bobbin, and
wherein a space is formed between the magnetostrictive rod and the bobbin on at least the side of the other end portion of the magnetostrictive rod.

16. The power generator as claimed in claim 15, wherein the other end portion of each of the magnetostrictive elements is displaced when vibration is applied to each of the magnetostrictive rods, and
wherein the space has a size for preventing the bobbin and the magnetostrictive rods being vibrating from interfering with each other.
